(19) United States
(12) Patent Application Publication
(10) Pub. No.: US 2026/0280632 A1
(43) Pub. Date: Sep. 17, 2026

(54) APPARATUS, METHOD, AND READABLE STORAGE MEDIUM FOR COMMUNICATION

(71) Applicant: Huawei Technologies Co., Ltd., Shenzhen (CN)

(72) Inventors: Aman Jassal, Stittsville (CA); Amine Maaref, Ottawa (CA); Jianglei Ma, Ottawa (CA)

(21) Appl. No.: 19/667,854

(22) Filed: May 5, 2026

Related U.S. Application Data
(63) Continuation of application No. PCT/CN2024/089366, filed on Apr. 23, 2024.
(60) Provisional application No. 63/598,657, filed on Nov. 14, 2023.

(51) Int. Cl. H04B 7/06; H04L 5/00; H04W 84/04

(52) U.S. Cl. CPC H04B 7/0617; H04L 5/0051; H04W 84/042

(57) ABSTRACT

The application relates to an apparatus, method, and readable storage medium for communication in the wireless communication field. In an example method, an apparatus can receive a set of beam angle information (BAI) from a first network device. The apparatus can receive a BAI subset from the first network device. The BAI subset includes at least one BAI, each of the at least one BAI represents a value corresponding to an angular direction, and the value is included in the set of BAI. The apparatus can communicate with the first network device using the at least one BAI.

### CROSS-REFERENCE TO RELATED APPLICATIONS

The present application is a continuation of International Application No. PCT/CN2024/089366, filed on Apr. 23, 2024, which claims priority to and the benefit of U.S. Provisional Patent Application Ser. No. 63/598,657, filed on Nov. 14, 2023, the entire contents of both of which applications are incorporated herein by reference.

### TECHNICAL FIELD

The present application relates generally to wireless communications. Particularly, it relates to an apparatus, method, and readable storage medium for communication.

### BACKGROUND

Wireless communications system such as fourth generation (4G) system (for example, Long-Term Evolution (LTE) system), fifth generation (5G) system (for example, New Radio (NR) system) have been deployed to provide various types of applications, such as message, voice, video and other data.

In NR, non-terrestrial networks (NTNs) are developed, which may utilize spaceborne vehicles such as satellites (including low earth orbiting (LEO) satellites, medium earth orbiting (MEO) satellites, geostationary earth orbiting (GEO) satellites as well as highly elliptical orbiting (HEO) satellites), or airborne vehicles (also called high-altitude platform) such as drones, or aircraft as a base station or relay for communications between different devices.

Either the satellites or the drones in NTNs may move at a high-speed relative to devices such as user equipments (UEs) operating within the NTNs, which is different from the scenario between UE and ground-based base station. In addition, the distance between the UE and the satellites or the drones is also much longer than the distance between UE and ground-based base station.

Accordingly, the solutions in NTNs, which may cooperate with terrestrial networks (TNs), to provide communications with acceptable cost (such as power consumption, and or complexity) are desired.

### SUMMARY

The following examples pertain to implementations described throughout this application.

In a first aspect, described may include an apparatus, comprising: at least one processor, wherein the at least one processor is configured to: receive a set of beam angle information (BAI) from a first network device; receive a first BAI subset from the first network device, wherein the first BAI subset includes at least one first BAI, each of the at least one first BAI represents a first value corresponding to a first angular direction, and the first value is included in the set of BAI; communicate with the first network device using the at least one first BAI.

In one or more possible implementations of the first aspect, the set of BAI indicates mapping relationship between reference values and reference angular directions, the reference values include the first value and the reference angular directions include the first angular direction.

In one or more possible implementations of the first aspect, the reference angular directions include zenith angles and/or azimuth angles of beams.

The set of BAI can be referred to the following Table 1 and/or Table 2. Table 1 shows a mapping relationship between reference zenith angles and corresponding reference values. For example, the “−70 degrees” is a kind of a reference zenith angle, and value “0000” is a kind of a reference value.

Table 2 shows a mapping relationship between reference azimuth angles and corresponding reference values. For example, the “0 degree” is a kind of a reference azimuth angle, and value “0000” is a kind of a reference value.

After the apparatus (e.g. a UE) receives a first BAI subset from the first network device, and the first BAI subset includes at least one first value, the apparatus may determine the at least one first angular direction corresponding to the at least first value based on the set of BAI. And then the apparatus can send beams based on the at least one first angular direction to communicate with the first network device. In this way, the apparatus doesn't need to spend time calculating the position of the first network device, decreasing the UE's workload and calculation complexity.

In one or more possible implementations of the first aspect, communicate with the first network device using the at least one first BAI, comprises: communicating with the first network device using the at least one first BAI when a first condition is met, wherein the first condition includes that a first zenith angle of a beam is less than a first zenith angle threshold.

The first BAI subset from the first network device to the apparatus can define a communication cone. That is to say, the apparatus may communicate with the first network device in this communication cone. Illustratively, because the first network device may keep moving relative to the apparatus, the first network device may not be located in the communication cone all the time. For example, if the first network moves beyond the communication cone, the apparatus may not communicate with the first network device.

Therefore, the apparatus can communicate with the first network device when a first condition is met, wherein the first condition includes that a first zenith angle of a beam is less than a first zenith angle threshold. Take the FIG. 14 as an example, the first zenith angle threshold is 20 degrees.

In one or more possible implementations of the first aspect, the at least one processor is further configured to: determine a first public land mobile network (PLMN) information used for communicating with a base station, wherein the first PLMN information is determined based on PLMN information set included in system information from the first network device, and the PLMN information set includes a second PLMN information used for communication between the apparatus and the first network device, and includes the first PLMN information; communicate with the base station based on the first PLMN information.

Before the apparatus initiates initial access to the first network device, the apparatus may obtain the system information sent by the first network device. In addition to a second PLMN information of the first network device, the system information may also include a first PLMN information of the base station. By doing so, when the apparatus connects two networks, the procedure for apparatus connecting the base station may be easier, and the connecting complexity will be decreased.

In one or more possible implementations of the first aspect, the system information further includes radio frequency (RF) channels and physical cell identities (PCI), and the at least one processor is further configured to: select a target cell based on the RF channels and the PCI, wherein the target cell is associated with the base station.

The system information sent by the first network device may further include RF channels and PCIs. In this way, after the apparatus obtains the first PLMN information of the first network device, the apparatus may select a target cell using the given RF channels and PCIs in the system information. And then, the apparatus may communicate with the base station. In conclusion, the RF channels and PCIs in the system information may reduce the time duration for the apparatus to select the target cell to connect with the base station.

In a second aspect, described may include an apparatus, comprising: at least one processor, wherein the at least one processor is configured to: receive a set of beam angle information (BAI) from a first network device; receive a second BAI subset from the first network device, wherein the second BAI subset includes at least one second BAI, each of the at least one second BAI represents a second value corresponding to a second angular direction, and the second value is included in the set of BAI; receive reference signals for at least one of mobility or beam management from a second network device using the at least one second BAI.

In one or more possible implementations of the second aspect, the set of BAI indicates mapping relationship between reference values and reference angular directions, the reference values include the second value and the reference angular directions include the second angular direction.

In one or more possible implementations of the second aspect, the reference angular directions include zenith angles and/or azimuth angles of beams.

The set of BAI can also be referred to the Table 1 and/or Table 2. The set of BAI here is the same as that mentioned in the first aspect, which will not be described herein again.

And the reference signals for at least one of mobility or beam management is referred to the mobility/beam management reference signals in the following content.

After the apparatus receives the second BAI subset from the first network device, the apparatus may determine the at least one second angular direction corresponding to the at least second value based on the set of BAI. The apparatus can send beams based on the at least one second angular direction to the second network device.

And then the apparatus can receive the mobility/beam management reference signals sent by the second network device. The apparatus may determine the second network device's direction relative to the apparatus by determining the angle of the mobility/beam management reference signals.

In one or more possible implementations of the second aspect, receive reference signals for at least one of mobility or beam management from a second network device using the at least one second BAI, comprises: receiving reference signals for at least one of mobility or beam management from the second network device using the at least one second BAI when a second condition is met, wherein the second condition includes that a second zenith angle of a reference signal of the reference signals for at least one mobility or beam management is greater than a second zenith angle threshold.

The apparatus may communicate with the network device in the communication cone, that is to say, if a network device isn't in the communication cone, the apparatus may not communicate with the network device. Therefore, the apparatus can just receive reference signals from the second network device when a second condition is met, wherein the second condition includes that a second zenith angle of a reference signal of the reference signals for at least one mobility or beam management is greater than a second zenith angle threshold. Take the FIG. 14 as an example, the first zenith angle threshold is 30 degrees.

In a third aspect, described may include a first network device, comprising: at least one processor, wherein the at least one processor is configured to: send a set of beam angle information (BAI) to an apparatus; send a first BAI subset to the apparatus, wherein the first BAI subset includes at least one first BAI, each of the at least one first BAI represents a first value corresponding to a first angular direction, and the first value is included in the set of BAI; communicate with the apparatus using the at least one first BAI.

In one or more possible implementations of the third aspect, the set of BAI indicates mapping relationship between reference values and reference angular directions, the reference values include the first value and the reference angular directions include the first angular direction.

In one or more possible implementations of the third aspect, the reference angular directions include zenith angles and/or azimuth angles of beams.

In one or more possible implementations of the third aspect, the at least one processor is further configured to: send a second BAI subset to the apparatus, wherein the second BAI subset includes at least one second BAI, each of the at least one second BAI represents a second value corresponding to a second angular direction, and the second value is included in the set of BAI.

In a fourth aspect, described may include a second network device, comprising: at least one processor, wherein the at least one processor is configured to: send reference signals for at least one of mobility or beam management to an apparatus based on beams sent by the apparatus using at least one second BAI in a second BAI subset, wherein the second BAI subset is sent by a first network device to the apparatus, and each of the at least one second BAI represents a second value corresponding to a second angular direction.

In a fifth aspect, described may include a method applied to an apparatus, comprising: receiving a set of beam angle information (BAI) from a first network device; receiving a first BAI subset from the first network device, wherein the first BAI subset includes at least one first BAI, each of the at least one first BAI represents a first value corresponding to a first angular direction, and the first value is included in the set of BAI; communicating with the first network device using the at least one first BAI.

In one or more possible implementations of the fifth aspect, the set of BAI indicates mapping relationship between reference values and reference angular directions, the reference values include the first value and the reference angular directions include the first angular direction.

In one or more possible implementations of the fifth aspect, the reference angular directions include zenith angles and/or azimuth angles of beams.

In one or more possible implementations of the fifth aspect, communicating with the first network device using the at least one first BAI, comprises: communicating with the first network device using the at least one first BAI when a first condition is met, wherein the first condition includes that a first zenith angle of a beam is less than a first zenith angle threshold.

In one or more possible implementations of the fifth aspect, the method further comprises: determining a first public land mobile network (PLMN) information used for communicating with a base station, wherein the first PLMN information is determined based on PLMN information set included in system information from the first network device, and the PLMN information set includes a second PLMN information used for communication between the apparatus and the first network device, and includes the first PLMN information; communicating with the base station based on the first PLMN information.

In one or more possible implementations of the fifth aspect, the system information further includes radio frequency (RF) channels and physical cell identities (PCI), and the method further comprises: select a target cell based on the RF channels and the PCI, wherein the target cell is associated with the base station.

In a sixth aspect, described may include a method applied to an apparatus, comprising: receiving a set of beam angle information (BAI) from a first network device; receiving a second BAI subset from the first network device, wherein the second BAI subset includes at least one second BAI, each of the at least one second BAI represents a second value corresponding to a second angular direction, and the second value is included in the set of BAI; receiving reference signals for at least one of mobility or beam management from a second network device using the at least one second BAI.

In one or more possible implementations of the sixth aspect, the set of BAI indicates mapping relationship between reference values and reference angular directions, the reference values include the second value and the reference angular directions include the second angular direction.

In one or more possible implementations of the sixth aspect, the reference angular directions include zenith angles and/or azimuth angles of beams.

In one or more possible implementations of the sixth aspect, receiving reference signals for at least one of mobility or beam management from a second network device using the at least one second BAI, comprises: receiving reference signals for at least one of mobility or beam management from the second network device using the at least one second BAI when a second condition is met, wherein the second condition includes that a second zenith angle of a reference signal of the reference signals for at least one mobility or beam management is greater than a second zenith angle threshold.

In a seventh aspect, described may include a method applied to a first network device, comprising: sending a set of beam angle information (BAI) to an apparatus; sending a first BAI subset to the apparatus, wherein the first BAI subset includes at least one first BAI, each of the at least one first BAI represents a first value corresponding to a first angular direction, and the first value is included in the set of BAI; communicating with the apparatus using the at least one first BAI.

In one or more possible implementations of the seventh aspect, the set of BAI indicates mapping relationship between reference values and reference angular directions, the reference values include the first value and the reference angular directions include the first angular direction.

In one or more possible implementations of the seventh aspect, the reference angular directions include zenith angles and/or azimuth angles of beams.

In one or more possible implementations of the seventh aspect, the method further comprises: sending a second BAI subset to the apparatus, wherein the second BAI subset includes at least one second BAI, each of the at least one second BAI represents a second value corresponding to a second angular direction, and the second value is included in the set of BAI.

In an eighth aspect, described may include a method applied to a second network device, comprising: sending reference signals for at least one of mobility or beam management to an apparatus based on beams sent by the apparatus using at least one second BAI in a second BAI subset, wherein the second BAI subset is sent by a first network device to the apparatus, and each of the at least one second BAI represents a second value corresponding to a second angular direction.

In a ninth aspect, described may include a machine-readable storage medium storing instructions, wherein when the instructions are executed by one or more processors of a machine, the instructions cause the machine to execute the method mentioned in the fifth, sixth, seventh and eighth aspects above.

The one or more implementations of the first aspect and the second aspect may also be applied to at least one of the third aspect to the ninth aspect.

The beneficial effects of the third aspect to the ninth aspect can be referred to those of the first aspect and the second aspect, which will not be described in detail herein.

### BRIEF DESCRIPTION OF THE DRAWINGS

FIG. 1 shows a first schematic structural diagram of a communication system 100 according to some examples of the present application.

FIG. 2 shows a second schematic structural diagram of a communication system 100 according to some examples of the present application.

FIG. 3 shows a schematic diagram of communication between apparatus 310 and apparatus 320 in a communication system 100 according to some examples of the present application.

FIG. 4 shows a schematic diagram of modules in each apparatus of a communication system 100 according to some examples of the present application.

FIG. 5 shows a schematic diagram where terrestrial TRPs are communicating with non-terrestrial TRPs that are part of a satellite constellation according to some examples of the present application.

FIG. 6 shows a schematic diagram where the satellite constellation acts as the Gateway for terrestrial TRPs on the ground according to some examples of the present application.

FIG. 7 shows a schematic diagram where the non-terrestrial TRPs communicate with terrestrial TRPs through the Core Network according to some examples of the present application.

FIG. 8 shows a schematic diagram of a “bent-pipe” scenario according to some examples of the present application.

FIG. 9 shows a schematic diagram of UEs in a coverage area according to some examples of the present application.

FIG. 10 shows a schematic flow diagram of a communication method according to some examples of the present application.

FIG. 11 shows a schematic diagram where the UE communicates with the first network device by serving BAIs according to some examples of the present application.

FIG. 12 shows a schematic flow diagram of another communication method according to some examples of the present application.

FIG. 13 shows a schematic diagram where the UE receives reference signals from the second network device by candidate BAIs according to some examples of the present application.

FIG. 14 shows a schematic diagram of a scenario including the UE, the first network device and the second network device according to some examples of the present application.

FIG. 15 shows a schematic diagram of a scenario where the NT-TRP is incoming the communication cone according to some examples of the present application.

FIG. 16 shows a schematic diagram of a scenario where the NT-TRP is outgoing the communication cone according to some examples of the present application.

FIG. 17 shows a schematic diagram of a scenario where UE switches its current serving BAI towards another serving BAI according to some examples of the present application.

FIG. 18 shows a schematic diagram of procedures for UE to camp on an NTN beam according to some examples of the present application.

FIG. 19 shows a schematic diagram of procedures for UE to establish connection with NTN according to some examples of the present application.

FIG. 20 shows a schematic diagram of procedures for UE to select TN cell according to some examples of the present application.

FIG. 21 shows a schematic diagram of procedures when UE leaves NTN connected mode or fails to find a suitable TN cell according to some examples of the present application.

### DETAILED DESCRIPTION OF ILLUSTRATIVE EMBODIMENTS

Illustrative implementations of the present application include, but are not limited to, an apparatus, method, and readable storage medium for communication.

The information in the background is provided to reveal information believed by the applicant to be of possible relevance to the present application. No admission is necessarily intended, nor should be construed, that any of the preceding information constitutes prior art against the present disclosure.

In the following description, reference is made to the accompanying figures, which form part of the present disclosure, and which show, by way of illustration, specific aspects of the present disclosure or specific aspects in which the present disclosure may be used. It is understood that one aspect of the present disclosure may be used in other aspects and include structural or logical changes not depicted in the figures. The following detailed description, therefore, is not to be taken in a limiting sense, and the scope of the present disclosure is defined by the appended claims.

To assist in understanding the present disclosure, examples of wireless communication systems and devices are described below. Referring to FIG. 1, as an illustrative example without limitation, a simplified schematic illustration of a communication system is provided. The communication system 100 (which may be a wireless system) comprises a radio access network 120. The radio access network (RAN) 120 may be a next generation (e.g. sixth generation (6G) or later) radio access network, or a legacy (e.g. 5G, 4G, 3G or 2nd generation (2G)) radio access network. One or more communication electronic device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. The communication system 100 may also comprise a public switched telephone network (PSTN) 140, the internet 150, and other networks 160.

In general, the communication system 100 enables multiple wireless or wired elements to communicate data and other content. The communication system 100 may provide content, such as voice, data, video, and/or text, via broadcast, multicast, groupcast, unicast, etc. And the communication system 100 may provide a wide range of communication services and applications (such as earth monitoring, remote sensing, passive sensing and positioning, navigation and tracking, autonomous delivery and mobility, etc.) The services and/or applications may be mobile broadband (MBB) services, ultra-reliable low-latency communication (URLLC) services, or machine type communication (MTC) services.

The communication system 100 may operate by sharing resources, such as carrier spectrum bandwidth, between its constituent elements.

FIG. 1 illustrates a more detailed example for communication system 100.

The communication system 100 may include a terrestrial communication system and/or a non-terrestrial communication system. The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. The heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system.

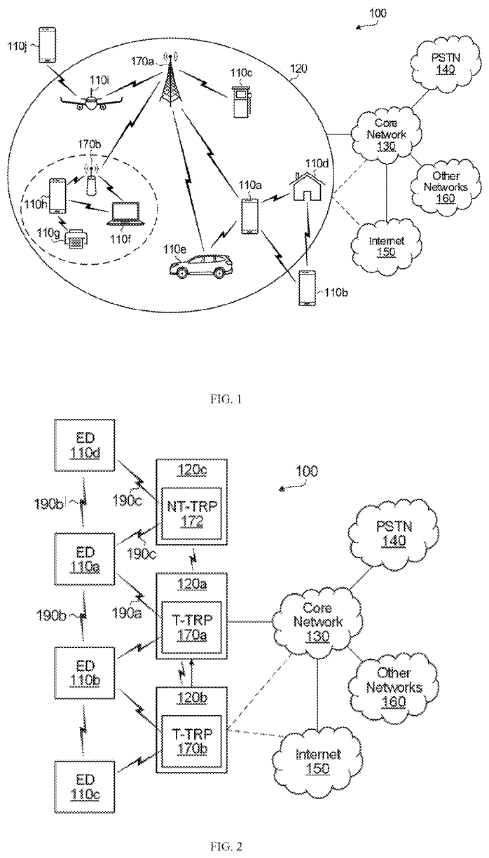

Same as in the example shown in FIG. 1, in the example shown in FIG. 2, the communication system 100 may include ED 110a, 110b, 110c, 110d (generically referred to as ED 110), and RAN 120a, 120b. In addition, the communication system 100 may also include a non-terrestrial communication network 120c. The communication system 100 may also include one or more of a core network 130, a public switched telephone network (PSTN) 140, the Internet 150, and other networks 160. The RANs 120a, 120b include respective RAN nodes such as base stations (BSs) 170a, 170b, which may be generically referred to as terrestrial transmit and receive points (T-TRPs) 170a, 170b. In one implementation, the non-terrestrial communication network 120c includes a RAN node such as an access node (or base station) 172, which may be generically referred to as a non-terrestrial transmit and receive point (NT-TRP) 172. As may be surmised on the basis of similarity in reference numerals, the non-terrestrial communication network 120c may be considered to be a radio access network, with operational aspects in common with the RANs 120a, 120b. In another implementations, the non-terrestrial communication network 120c may include at least one non-terrestrial network (NTN) device and at least one corresponding terrestrial network device, wherein the at least one non-terrestrial network device works as a transport layer device and the at least one corresponding terrestrial network device works as a RAN node, which communicates with the ED via the non-terrestrial network device. In addition, there may be a NTN gateway in the ground (i.e., referred as a terrestrial network device) also as a transport layer device to communication with both the NTN device, and the RAN node communicates with the ED via the NTN device and the NTN gateway. In some implementations, the NTN gateway and the RAN node may be located in the same device.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, ED 110a may communicate an uplink (UL) and/or downlink (DL) transmission over a terrestrial air interface 190a with T-TRP 170a. In some examples, the EDs 110a, 110b, 110c, and 110d may also communicate directly with one another via one or more sidelink (SL) air interfaces 190b. In some examples, ED 110d may communicate an uplink and/or downlink transmission over a non-terrestrial air interface 190c with NT-TRP 172.

An air interface (e.g., 190a, 190b, 190c) generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link (e.g., a “Uu” link) between a radio access network (e.g., RAN 120) and user equipment (e.g., ED 110) and/or the wireless communications link may support a link (e.g., a “LS”) between device (e.g., ED 110a) and device (e.g., ED 110b), such as between two user equipments, and/or the wireless communications link may support a link between a non-terrestrial (NT)-communication network (e.g., RAN 120c) and user equipment (e.g., ED 110d). The following are some examples for the above components.

A waveform component may specify a shape and form of a signal being transmitted. Waveform options may include orthogonal multiple access waveforms and non-orthogonal multiple access waveforms. Non-limiting examples of such waveform options include orthogonal frequency division multiplexing (OFDM), discrete Fourier transform spread OFDM (DFT-OFDM), filtered OFDM (f-OFDM), time windowing OFDM, filter bank multicarrier (FBMC), universal filtered multicarrier (UFMC), generalized frequency division multiplexing (GFDM), wavelet packet modulation (WPM), faster than Nyquist (FTN) waveform and low peak to average power ratio waveform (low PAPR WF).

A frame structure component may specify a configuration of a frame or group of frames. The frame structure component may indicate one or more of a time, frequency, pilot signature, code, subcarrier spacing, cyclic prefix length or other parameter of the frame or group of frames. More details of frame structure will be discussed hereinafter.

A multiple access scheme component may specify multiple access technique options, including technologies defining how communicating devices share a common physical channel, such as: code division multiple access (CDMA), space division multiple access (SDMA), time division multiple access (TDMA), frequency division multiple access (FDMA), orthogonal FDMA (OFDMA), single-carrier FDMA (SC-FDMA) which is also known as discrete Fourier transform spread OFDMA (DFT-s-OFDMA), low density signature multicarrier CDMA (LDS-MC-CDMA); non-orthogonal multiple access (NOMA); pattern division multiple access (PDMA); lattice partition multiple access (LPMA); resource spread multiple access (RSMA); and sparse code multiple access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access. The air interfaces 190a and 190b may utilize other higher dimension signal spaces, which may involve a combination of orthogonal and/or non-orthogonal dimensions.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low peak-to-average power ratio (PAPR) modulation.

The air interfaces 190a and 190b may use similar communication technology, such as any suitable radio access technology.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP), user datagram protocol (UDP). EDs 110a 110b, and 110c may be multimode devices capable of operation according to multiple radio access technologies, and incorporate multiple transceivers necessary to support such.

In addition, the communication system 100 may comprising a sensing agent (not shown in the figure) to manage the sensed data from ED 110 and or the T-TRP 170 and/or NT-TRP 172. In one implementation, the sensing agent is located in the T-TRP 170 and/or NT-TRP 172. In another implementation, the sensing agent is a separate node which has interface to communicate with the core network 130 and/or the RAN 120 (e.g., the T-TRP 170 and/or NT-TRP 172).

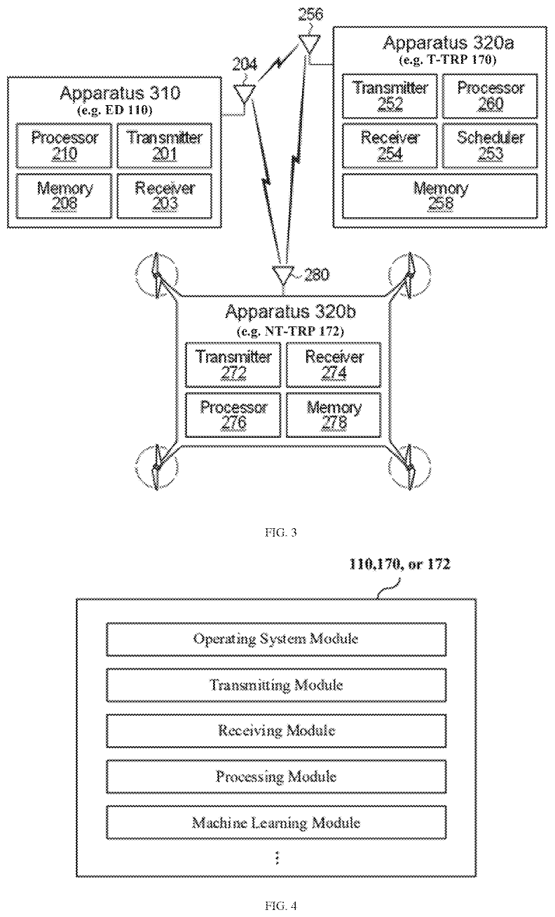

FIG. 3 illustrates example of an Apparatus 310 wirelessly communicating with at least one of two apparatuses (e.g., Apparatus 320a and Apparatus 320b, referred as Apparatus 320) in a communication system, e.g., the communication system 100, according to one embodiment. The Apparatus 310 may be a UE (e.g., ED 110 in FIG. 2). The Apparatus 320a may be a terrestrial network device (e.g., T-TRP 170 as shown in FIG. 2), and Apparatus 320b may be a non-terrestrial network device (e.g., NT-TRP 172 as shown in FIG. 2). However, this is not necessary. For example, Apparatus 320a may be a NT-TRP, and 320b may be a T-TRP, both Apparatus 320a and 320b may be T-TRPs or NT-TRPs, according to present disclosure. In the following, the ED 110 as an example of the Apparatus 310 is described, and T-TRP 170 as an example of Apparatus 320a is described, and NT-TRP 172 as an example of Apparatus 320b is described. Although there is only one Apparatus 310, one Apparatus 320a and one Apparatus 320b, please note that the number of Apparatus 310 (e.g. ED 110) could be one or more, and the number of Apparatus 320a and/or 320b could be one or more. For example, one ED 110 may be served by only one T-TRP 170 (or one NT-TRP 172), by more than one T-TRP 170, by more than one NT-TRP 172, or by one or more T-TRP 170 and one or more NT-TRP 172.

The ED 110 is used to connect persons, objects, machines, etc. The ED 110 may be widely used in various scenarios including, for example, cellular communications, device-to-device (D2D), vehicle to everything (V2X), peer-to-peer (P2P), machine-to-machine (M2M), MTC, internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to but not limited to) as a user equipment/device (UE), a wireless transmit/receive unit (WTRU), a mobile station, a fixed or mobile subscriber unit, a cellular telephone, a station (STA), a MTC device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modem, or chip) or comprising the forgoing devices, among other possibilities. Future generation EDs 110 may be referred to using other terms. The base station 170a and 170b is a T-TRP and will hereafter be referred to as T-TRP 170. Also shown in FIG. 3, a non-terrestrial (NT) device will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

As shown in FIG. 3, the ED 110 can include at least one processor 210. Only one processor 210 is illustrated to avoid congestion in the drawing. The ED 110 may further include a transmitter 201 and a receiver 203 coupled to one or more antennas 204. Only one antenna 204 is illustrated to avoid congestion in the drawing. One, some, or all of the antennas 204 may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals. The ED 110 may include at least one memory 208. Only the transmitter 201, receiver 203, processor 210, memory 208, and antenna 204 is illustrated for simplicity, but the ED 110 may include one or more other components.

The memory 208 stores instructions. The memory 208 may also store data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, etc.

The processor 210 performs (or controls the ED 110 to perform) operations described herein as being performed by the ED 110. As illustrated below and elsewhere in the present disclosure. For example, the processor 210 performs or controls the ED 110 to perform receiving transport blocks (TBs), using a resource for decoding of one of the received TBs, releasing the resource for decoding of another of the received TBs, and/or receiving configuration information configuring a resource. In details, the operation may include those operations related to preparing a transmission for uplink transmission to the NT-TRP 172 and/or the T-TRP 170; those operations related to processing downlink transmissions received from the NT-TRP 172 and/or the T-TRP 170; and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Processing operations related to processing sidelink transmissions may include operations such as transmit/receive beamforming, modulating/demodulating and encoding/decoding symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by the NT-TRP 172 and/or by the T-TRP 170. In some implementations, the processor 210 implements the transmit beamforming and/or the receive beamforming based on the indication of beam direction, e.g. beam angle information (BAI), received from the T-TRP 170. In some implementations, the processor 210 may perform operations relating to network access (e.g. initial access) and/or downlink synchronization, such as operations relating to detecting a synchronization sequence, decoding and obtaining the system information, etc. In some implementations, the processor 210 may perform channel estimation, e.g. using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201, and the processing components of the receiver 203 may each be implemented by the same or different one or more processors that are configured to execute instructions stored in a memory (e.g. in the memory 208). Alternatively, some or all of the processor 210, the processing components of the transmitter 201, and the processing components of the receiver 203 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

In some implementations, the ED 110 may be an apparatus (also called component) for example, communication module, modem, chip, or chipset, it includes at least one processor 210, and an interface or at least one pin. In this scenario, the transmitter 201 and receiver 203 may be replaced by the interface or at least one pin, where the interface or at least one pin is to connect the apparatus (e.g., chip) and other apparatus (e.g., chip, memory, or bus). Accordingly, the transmitting information to the NT-TRP 172 and/or the T-TRP 170 and/or another ED 110 may be referred as transmitting information to the interface or at least one pin, or as transmitting information to the NT-TRP 172 and/or the T-TRP 170 and/or another ED 110 via the interface or at least one pin, and receiving information from the NT-TRP 172 and/or the T-TRP 170 and/or another ED 110 may be referred as receiving information from the interface or at least one pin, or as receiving information from the NT-TRP 172 and/or the T-TRP 170 and/or another ED 110 via the interface or at least one pin. The information may include control signaling and/or data. For other nodes/entities in this disclosure, similar rule applies.

As shown in FIG. 3, the T-TRP 170 can include at least one processor 260. Only one processor 260 is illustrated to avoid congestion in the drawing. The T-TRP 170 may further include at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 may further include at least one memory 258. The T-TRP 170 may further include scheduler 253. Only the transmitter 252, receiver 254, processor 260, memory 258, antenna 256 and scheduler 253 are illustrated for simplicity, but the T-TRP may include one or more other components.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro base station (BS), a pico BS, a relay node, a donor node, or the like, or combinations thereof. The T-TRP 170 may refer to the forgoing devices or refer to apparatus (e.g. a communication module, a modem, or a chip) in the forgoing devices.

In some implementations, the parts of the T-TRP 170 may be distributed. For example, some of the modules of the T-TRP 170 may be located remotely from the equipment that houses the antennas 256 for the T-TRP 170, and may be coupled to the equipment that houses the antennas 256 over a communication link (not shown) sometimes known as front haul, such as common public radio interface (CPRI). Therefore, in some implementations, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some implementations, the T-TRP 170 may actually be a plurality of T-TRPs that are operating together to serve the ED 110, e.g. through the use of coordinated multipoint transmissions.

The processor 260 performs operations including those related to: preparing a transmission for downlink transmission to the ED 110, processing an uplink transmission received from the ED 110, preparing a transmission for backhaul transmission to the T-TRP 170 and/or NT-TRP 172, and processing a transmission received over backhaul from the T-TRP 170 and/or NT-TRP 172. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 260 may also perform operations relating to network access (e.g. initial access) and/or downlink synchronization, such as generating the content of synchronization signal blocks (SSBs), generating the system information, etc. In some implementations, the processor 260 also generates an indication of beam direction, e.g. BAI, which may be scheduled for transmission by a scheduler 253. The processor 260 performs other network-side processing operations described herein, such as determining the location of the ED 110, determining where to deploy the NT-TRP 172, etc. In some implementations, the processor 260 may generate signaling, e.g. to configure one or more parameters of the ED 110 and/or one or more parameters of the NT-TRP 172. Any signaling generated by the processor 260 is sent by the transmitter 252.

The scheduler 253 may be coupled to the processor 260 or integrated in the processor 260. The scheduler 253 may be included within or operated separately from the T-TRP 170. The scheduler 253 may schedule uplink, downlink, sidelink, and/or backhaul transmissions, including issuing scheduling grants and/or configuring scheduling-free (e.g., “configured grant”) resources.

The memory 258 is configured to store information, and optionally data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252, and the processing components of the receiver 254 may each be implemented by the same or different one or more processors that are configured to execute instructions stored in a memory, e.g. in the memory 258. Alternatively, some or all of the processor 260, the scheduler 253, the processing components of the transmitter 252, and the processing components of the receiver 254 may be implemented using dedicated circuitry, such as a programmed FPGA, a hardware accelerator (e.g., a GPU or AI accelerator), or an ASIC.

When the T-TRP 170 is an apparatus (also called as component), for example, communication module, modem, chip, or chipset in a device, it includes at least one processor, and an interface or at least one pin. In this scenario, the transmitter 252 and receiver 254 may be replaced by the interface or at least one pin, where the interface or at least one pin is to connect the apparatus (e.g., chip) and other apparatus (e.g., chip, memory, or bus). Accordingly, the transmitting information to the NT-TRP 172 and/or the T-TRP 170 and/or ED 110 may be referred as transmitting information to the interface or at least one pin, and receiving information from the NT-TRP 172 and/or the T-TRP 170 and/or ED 110 may be referred as receiving information from the interface or at least one pin. The information may include control signaling and/or data.

Although the NT-TRP 172 is illustrated as a drone only as an example, the NT-TRP 172 may be implemented in any suitable non-terrestrial form, such as satellites and high altitude platforms, including international mobile telecommunication base stations and unmanned aerial vehicles, for example. Also, the NT-TRP 172 may be known by other names in some implementations, such as a non-terrestrial node, a non-terrestrial network device, or a non-terrestrial base station.

As shown in FIG. 3, the T-TRP 170 may further include at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 may further include at least one memory 258. The T-TRP 170 may further include scheduler 253. Only the transmitter 252, receiver 254, processor 260, memory 258, antenna 256 and scheduler 253 are illustrated for simplicity, but the T-TRP may include one or more other components.

As shown in FIG. 3, the NT-TRP 172 include at least one processor 276. Only one processor 276 is illustrated to avoid congestion in the drawing. The NT-TRP 172 may include a transmitter 272 and a receiver 274 coupled to one or more antennas 280. Only one antenna 280 is illustrated to avoid congestion in the drawing. One, some, or all of the antennas may alternatively be panels. The transmitter 272 and the receiver 274 may be integrated as a transceiver. The NT-TRP 172 may further include at least one memory 278. The NT-TRP 172 may further include scheduler. Only the transmitter 272, receiver 274, processor 276, memory 278, antenna 280 are illustrated for simplicity, but the NT-TRP may include one or more other components.

The NT-TRP 172 include a processor 276 for performing operations including those related to: preparing a transmission for downlink transmission to the ED 110, processing an uplink transmission received from the ED 110, preparing a transmission for backhaul transmission to T-TRP 170 and/or another NT-TRP 172, and processing a transmission received over backhaul from the T-TRP 170 and/or another NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some implementations, the processor 276 implements the transmit beamforming and/or receive beamforming based on beam direction information (e.g. BAI) received from the T-TRP 170. In some implementations, the processor 276 may generate signaling, e.g. to configure one or more parameters of the ED 110. In some implementations, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The memory 278 is configured to store information and optionally data. The memory 258 stores instructions and data used, generated, or collected by the NT-TRP 172. For example, the memory 278 could store software instructions or modules configured to implement some or all of the functionality and/or embodiments described herein and that are executed by the processor 276.

Although not illustrated, the processor 276 may form part of the transmitter 272 and/or part of the receiver 274. Although not illustrated, the memory 278 may form part of the processor 276.

The processor 276, the processing components of the transmitter 272, and the processing components of the receiver 274 may each be implemented by the same or different one or more processors that are configured to execute instructions stored in a memory, e.g. in the memory 278. Alternatively, some or all of the processor 276, the processing components of the transmitter 272, and the processing components of the receiver 274 may be implemented using dedicated circuitry, such as a programmed FPGA, a hardware accelerator (e.g., a GPU or AI accelerator), or an ASIC. In some implementations, the NT-TRP 172 may actually be a plurality of NT-TRPs that are operating together to serve the ED 110, e.g. through coordinated multipoint transmissions.

When the NT-TRP 172 is an apparatus (e.g. communication module, modem, chip, or chipset) in a device, it includes at least one processor, and an interface or at least one pin. In this scenario, the transmitter 272 and receiver 257 may be replaced by the interface or at least one pin, where the interface or at least one pin is to connect the apparatus (e.g., chip) and other apparatus (e.g., chip, memory, or bus). Accordingly, the transmitting information to the T-TRP 170 and/or another NT-TRP 172 and/or ED 110 may be referred as transmitting information to the interface or at least one pin, and receiving information from the T-TRP 170 and/or another NT-TRP 172 and/or ED 110 may be referred as receiving information from the interface or at least one pin. The information may include control signaling and/or data.

Note that “transmit/receive point (TRP)”, as used herein, may refer to a T-TRP or a NT-TRP. A T-TRP may alternatively be called a terrestrial network TRP (“TN TRP”) and a NT-TRP may alternatively be called a non-terrestrial network TRP (“NTN TRP”). The T-TRP 170, the NT-TRP 172, and/or the ED 110 may include other components, but these have been omitted for the sake of clarity.

Note that “signaling”, as used herein, may alternatively be called control signaling, control message, control information, or message for simplicity. Signaling between a BS (e.g., the network node 170) and a terminal or sensing device (e.g., ED 110), or signaling between different terminal or sensing device (e.g., between ED 110i and ED 110j) may be carried in physical layer signaling (also called as dynamic signaling), which is transmitted in a physical layer control channel. For downlink the physical layer signaling may be known as downlink control information (DCI) which is transmitted in a physical downlink control channel (PDCCH). For uplink, the physical layer signaling may be known as uplink control information (UCI) which is transmitted in a physical uplink control channel (PUCCH). For sidelink, signaling between different terminal or sensing device (e.g., between ED 110i and ED 110j) may be known as sidelink control information (SCI) which is transmitted in a physical sidelink control channel (PSCCH). Signaling may be carried in a higher-layer (e.g., higher than physical layer) signaling, which is transmitted in a physical layer data channel, e.g. in a physical downlink shared channel (PDSCH) for downlink signaling, in a physical uplink shared channel (PUSCH) for uplink signaling, and in a physical sidelink shared channel (PSSCH) for sidelink signaling. Higher-layer signaling may also be called static signaling, or semi-static signaling. Higher-layer signaling may be radio resource control (RRC) protocol signaling or media access control-control element (MAC-CE) signaling. Signaling may be included in a combination of physical layer signaling and higher layer signaling.

It should be noted that in present disclosure, “information”, when different from “message”, may be carried in one single message, or be carried in more than one separate message.

One or more steps of the methods provided in this disclosure herein may be performed by corresponding units or modules, according to FIG. 4. FIG. 4 illustrates units or modules in a device or apparatus, such as in the ED 110, in the T-TRP 170, or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be a circuit such as an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation. For other nodes/entities in this disclosure, similar units or modules apply.

Additional details regarding the EDs 110, the T-TRP 170, and the NT-TRP 172 are known to those of skill in the art. As such, these details are omitted here.

The disclosure of the present application is aimed at devices such as UEs, IoT devices, cars, etc. The type of network scenarios envisioned may include terrestrial TRPs such as base-stations and/or non-terrestrial TRPs such as drones, balloons, high-altitude platform stations (HAPS), satellites, and any such devices that support radio access technologies such as 5G NR, future 6G systems.

FIG. 5 shows an example scenario where terrestrial TRPs are communicating with non-terrestrial TRPs that are part of a satellite constellation. A satellite constellation is typically constituted of a plurality of satellite orbits such that Earth is always provided with wireless coverage from the satellites, and each satellite orbits may have a plurality of satellites in it. Terrestrial TRPs may be connected to the Core Network (CN) through terrestrial Gateways while satellite constellations may be connected to the Core Network through dedicated non-terrestrial Gateways. Devices such as UEs may connect and communicate with a terrestrial TRP (T-TRP) or with a non-terrestrial TRP (NT-TRP), depending on the conditions of traffic load, radio link quality, congestion, and so on.

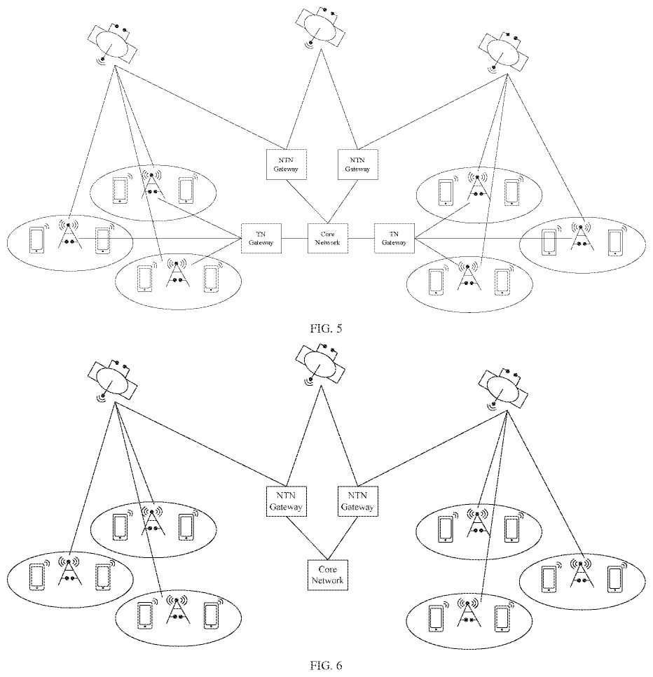

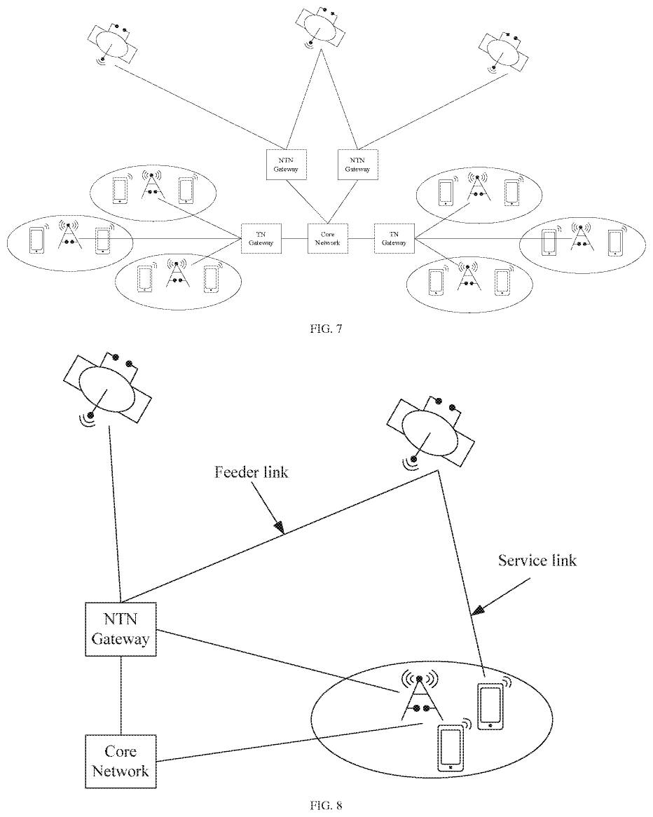

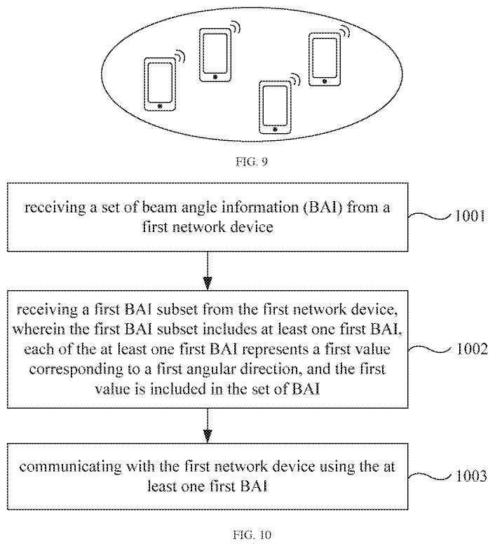

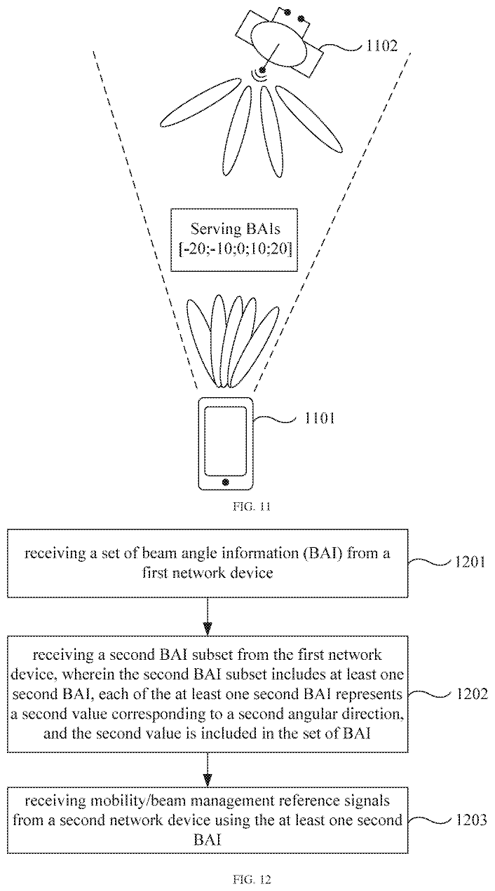

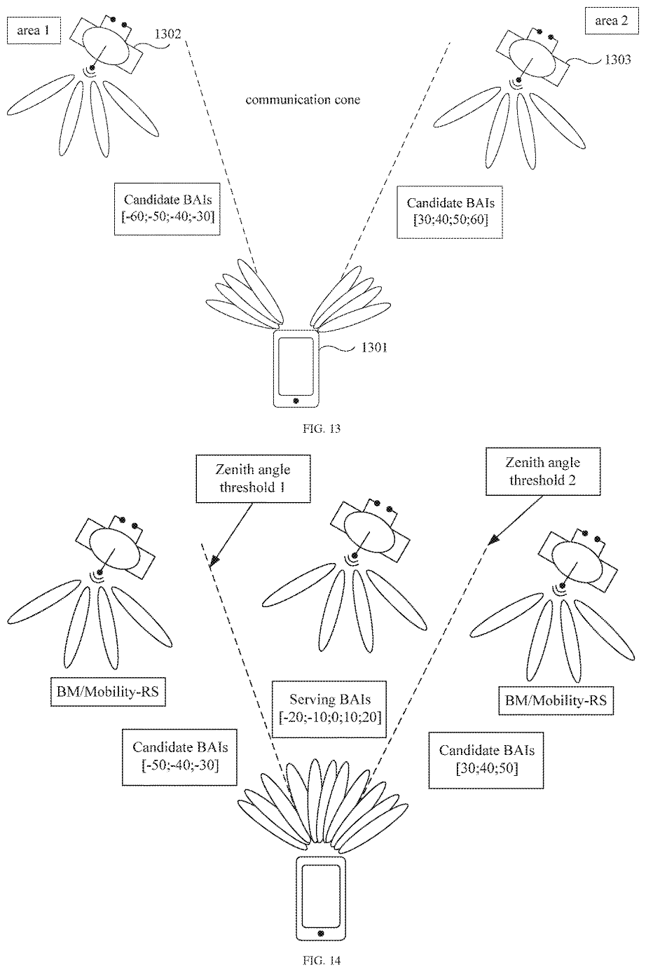

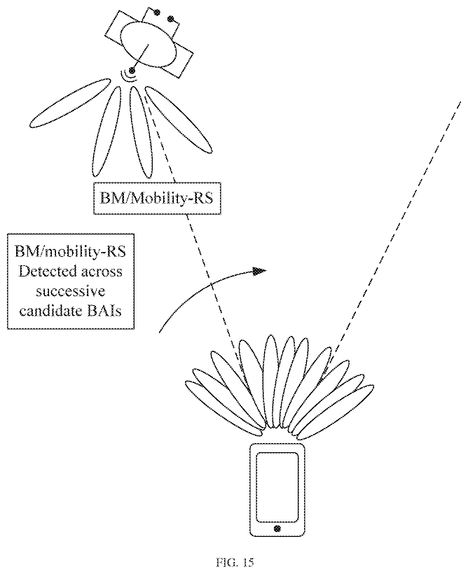

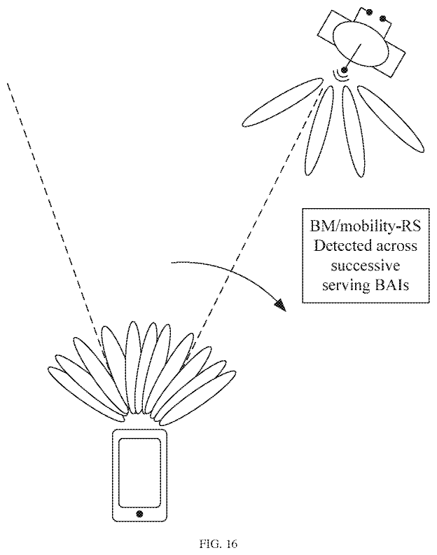

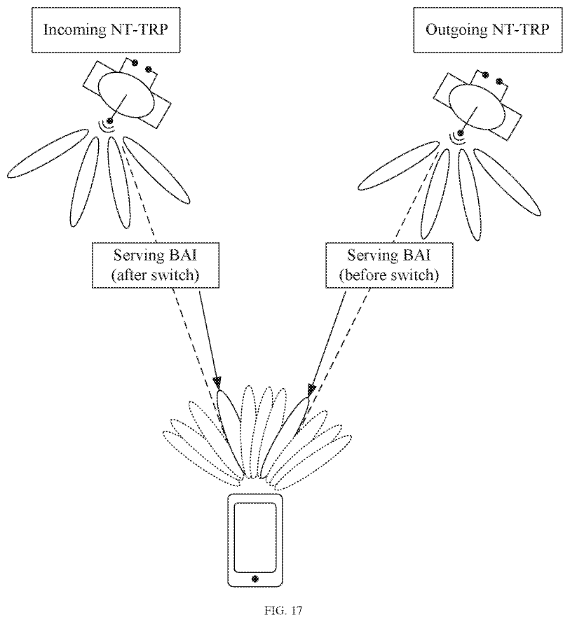

There are several ways for communication among the core network, the T-TRPs, and the NT-TRPs. For example, the T-TRPs can directly communicate with the NT-TRPs, or the T-TRPs can communicate with Core Network through the NT-TRPs (shown in FIG. 6), or the T-TRPs can communicate with the NT-TRPs through the Core Network (shown in FIG. 7).

FIG. 6 shows another example scenario where the satellite constellation effectively acts as the Gateway for terrestrial TRPs on the ground. Satellites in the satellite constellation communicate with the Core Network through Gateways located on the ground using a wireless link, while the Gateways on the ground use a wired link (e.g. fiber optical link) to communicate with the Core Network. Terrestrial TRPs communicate with satellites using a wireless link and satellites communicate between each-other using free space optical links (using e.g. lasers). Devices such as UEs may connect and communicate with a terrestrial TRP or with a non-terrestrial TRP, depending on the conditions of traffic load, radio link quality, congestion, and so on.

FIG. 7 shows another scenario where the non-terrestrial TRPs communicate with terrestrial TRPs through the Core Network. Non-terrestrial TRPs may first communicate with dedicated non-terrestrial Gateways, which then communicate with the Core Network. The Core Network may then relay the power saving commands from non-terrestrial TRPs to terrestrial TRPs via dedicated terrestrial Gateways. Devices such as UEs may connect and communicate with a terrestrial TRP or with a non-terrestrial TRP, depending on the conditions of traffic load, radio link quality, congestion, and so on.

In some possible implementations, a UE could communicate with the CN via one NT-TRP and one NTN-gateway which may be called one hop communication. In some other possible implementations, a UE could communicate with the CN via more than one NT-TRP and/or more than one NTN-gateway which may be called multi-hop communication.

For illustrative purposes, specific example embodiments will now be explained in greater detail in conjunction with the figures and above mentioned system, ED and TRP.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

According to related description on above several scenarios of NT-TRP and T-TRP communication, it can be learned that a UE can communicate with a base station on the ground, and also can communicate with a satellite directly.

For communication between a UE and a base station on the ground, in cellular systems such as 5G NR, the UE can receive, detect and measure reference signals such as SS/PBCH blocks and NZP-CSI-RS. Such reference signals are based on pseudo random noise (PRN) binary sequences such as Gold sequences and those sequences may be initialized using common or UE-specific scrambling identities. As an example, primary synchronization signal (PSS) and secondary synchronization signal (SSS) sequences are initialized using the physical cell identity (PCI) value, which is a common scrambling identity. NZP-CSI-RS sequences are initialized using UE-specific scrambling identities, which are configured by the network to the UE.

While in 5G NR Rel-17, NTN was introduced allowing UEs to support DL/UL communication with satellites using the so-called “bent-pipe” scenario, where a ground station transmits signals towards satellites in space, and satellites reflect signals back to UEs on the ground. Dedicating signaling related to NTN was introduced in order to assist UEs with NTN operation. Higher-layer signaling such as radio resource control (RRC) introduces signaling satellite ephemeris, satellite position, satellite signal polarization, timing advance offsets, satellite System Information Block (SIB), satellite epochs in order to support NTN operation. Other features that were introduced were the extension of hybrid automatic repeat request (HARQ) processes to 32 in order to accommodate for large propagation delay scenarios and the disabling of HARQ-ACK feedback.

5G NR Rel-17 introduces support for non-terrestrial networks by introducing several enhancements on the timing relationships for the timing advance (TA), the reference timing for channel state information (CSI) resources, the transmission timing of DCIs scheduling PUSCH, the transmission timing of Random Access response carried by a PDSCH, the transmission timing of HARQ-ACK on a PUCCH.

5G NR Rel-17 also introduces a solution combining closed-loop and open-loop Timing Advance compensation, where the closed-loop part is controlled by the network and the open-loop part is carried out by the UE. The compensation from the UE may be based on the knowledge of the satellite's ephemeris (e.g. parameters such as the satellite's orbital angles).

5G NR Rel-17 supports so-called “bent-pipe” scenarios as shown in FIG. 8, i.e. the base-station is located behind a NTN gateway on the ground, the NTN gateway sends a transmission towards the satellite (this link is called the “feeder” link) and the satellite transmits the transmission towards UEs on the ground (this link is called the “service” link).

Satellites transmit multiple beams towards the ground and it is assumed that each beam is associated with a given “physical cell identity”. It is also assumed that satellites transmit beams in a “fixed” manner, where “fixed” means that the satellite isn't steering its beams towards a given direction, instead the beams “slide” on the surface of Earth and thus appear to be “moving” from the perspective of devices (e.g. UE) on the ground.

In 5G NR Rel-18, NTN was further enhanced to introduce Coverage enhancements for NTN, network-verified UE location, as well as support TN to NTN and NTN to NTN mobility scenarios.

The support introduced in 5G NR Rel-17 for NTN is based on a non-transparent design in the sense that every satellite is effectively seen by devices such as UEs, IoT devices, cars, etc., as a serving cell. Devices are also made aware of the satellite's ephemeris as well as the satellite's position at any given time as the satellite explicitly broadcasts it within System Information Block 19 (SIB19), which is transmitted by satellites in order to assist devices such as UEs with assistance information for NTN access. This results in a non-transparent radio access design which prevents smooth integration of transmit diversity schemes, multi-TRP transmission schemes and distributed satellite systems.

In the case of low earth orbit (LEO) NTN access, satellites are constantly in movement and therefore are in line-of-sight to devices on the ground for a limited amount of time. Taking the Starlink constellation as an example, a LEO satellite may be in line-of-sight of a given device on the ground for a duration in order of several minutes. As a result, any information that the satellite transmits or broadcasts to devices on the ground becomes outdated within a few minutes and constantly needs to be updated in order for the satellite communication to be working (due to ever changing timing advance for uplink synchronization, and the need to (re-)acquire downlink synchronization). This results in high signaling overhead between satellites and devices on the ground just to keep the communication link operational.

LEO satellites use the fixed-beam model in order to transmit signals and channels towards devices on the ground. This results in satellite beams “sliding” across the surface of Earth, which triggers mobility and handover procedures whenever devices are located at the edge between two beams. Mobility and handover procedures typically cause delays and interruptions as the RRC connection needs to be re-established upon entering the target cell, which hurts the overall user experience.

Random Access procedure may be another potential bottleneck in communication systems. There may be several millions of devices on the ground within a given coverage area, if these several million devices were to attempt Random Access within a short time interval, it may not be conceivable or feasible for non-terrestrial TRPs to be able to detect individual Random Access preambles transmitted by so many devices within this short time interval. This is because of the prohibitively high complexity this would incur on non-terrestrial TRPs. Non-terrestrial TRPs are ultimately embedded systems and they may not be able to do the processing related to receiving, detecting and measuring so many Random Access preambles within such a short time interval.

The approach in 5G NR Rel-17 support for NTN is based on assigning unique physical cell identities (PCIs) to different beams. Combined with the use of fixed-beams, this creates two types of interference problems in terms of reference signal measurement and/or communication of physical layer channels. The first problem is that of “PCI confusion”, which occurs when two or more neighbor beams are using the same PCI. The second problem is that of “PCI collision”, which occurs when a neighbor beam is using the same PCI as the serving beam. Both problems may occur when beams transmitted from different satellites start to overlap with each-other.

As LEO satellites go along their orbits, inevitably they move away from a given coverage area and all UEs in that coverage area need to go through a mobility procedure in order to maintain their connection with the e.g. LEO satellites. This inherently incurs latency because of having to re-establish the RRC connection with the target satellites, and this problem is made even worse in NTN LEO scenarios because such handovers would occur continuously.

Take that a LEO satellite is communicating with a UE as an example, because the satellite keeps “moving” relative to a UE, when the satellite moves away from a certain coverage (e.g. the satellite moves to the other hemisphere, or the satellite moves beyond the beam range of the UE), the satellite may not communicate with the UE. Then UE may take a time duration to find another target satellite that the UE can communicate with. And then UE may re-establish RRC connection with the target satellite to ensure the communication. So when such handovers occur continuously in NTN LEO scenarios, it may take a lot of time (duration) for UE to find target satellite(s). As a result, the UE's connectivity with the e.g. LEO satellites is interrupted and reset every time a handover needs to take place, which degrades the user experience for the UE.

In addition, even when the satellite lies in the certain coverage, because the satellite keeps “moving” relative to the UE, the UE may need to calculate the position of the satellite in real time, so that the UE can send its beams correctly to the satellite. Usually, the UE may calculate the position by the satellite's ephemeris broadcasted by the satellite. In this context, the UE needs to calculate the position of the satellite, increasing the UE's workload and calculation complexity during communication.

In order to solve above technical problems, the present disclosure discloses a method. In this method, the first network device (e.g. a satellite) can send a first beam angle information (BAI) list (as an example of the first BAI subset) to the UE, where the first BAI list can indicate the first network device's position relative to the UE at different times. And also the first BAI list may indicate a communication cone where the UE can communicate with the first network device. After the UE receives the first BAI list, it can generate transmit/receive beams (or equivalently transmit/receive spatial filters) towards the first network device on the basis of the first BAI list, to communicate with the first network device. In this way, the UE doesn't need to spend time calculating the position of the first network device. Instead, it can just communicate with the first network device based on the first BAI list, decreasing the UE's workload and calculation complexity.

In addition, the UE can also detect if the first network device is “outgoing” the communication cone on the basis of the first BAI list. If so, the UE may not communicate with the first network device any longer. And then, the UE can determine if there is another satellite which is lying in the communication cone or which is “incoming” the communication cone. If so, the UE can communicate with the satellite.

In some possible implementations, there may also be a second network device, which is located outside of the communication cone that the first BAI list defines. The first network device can send a second BAI list (as an example of the second BAI subset) to the UE, where the second BAI list can indicate the second network device's position relative to the UE at different times. After the UE receives the second BAI list, it can generate transmit/receive beams (or equivalently transmit/receive spatial filters) towards the second network device on the basis of the second BAI list, to detect if the second network is “incoming” the communication cone. If so, and the UE finds that the first network device is “outgoing” or has already located outside of the communication cone, the UE may communicate with the second network device instead of the first network device.

By doing so, the UE may not need to spend time (duration) finding the target network device (e.g. the second network device above) after the UE doesn't communicate with the first network device. Instead, the UE can directly communicate with the second network device in the method mentioned in former content. Therefore, the communication efficiency is improved when a handover takes place, thus improving the user experience of the UE.

In some possible implementations, the UE may have different transmit/receive beams (or equivalently: different transmit/receive spatial filters) where a given transmit/receive beam may be associated with a given BAI. BAIs may be associated with a given plane, e.g. the horizontal plane also called the azimuth plane, and/or the vertical plane also called the zenith plane. The zenith plane may also be alternatively called the elevation plane. Zenith angles and elevation angles have the relationship shown in the following formula (1):

Zenith angle=90 degrees~elevation angle formula (1)

Therefore, each BAI in the first BAI list and the second BAI list may be associated with an azimuth plane and or zenith plane, which means that each BAI may include at least one of azimuth angle and zenith angle.

In some possible implementations, the UE includes but is not limited to cell phones, tablets, wearable devices, augmented reality (AR) devices, and other arbitrary electronic devices, the type and form of which isn't restricted in this application. In addition, the first network device and the second network device may be two satellites in the same orbit.

Before describing in details the communication method in the present disclosure, the application scenario of this method will be described first.

FIG. 9 shows a schematic diagram of UEs according to some embodiments of this disclosure. As shown in FIG. 9, there is a coverage area on the ground and one or more devices e.g. UEs are within this coverage area.

The UEs may be connected to a network, which may be a non-terrestrial network, i.e. that UEs may have an RRC connection with the network and are in connected mode, or UEs may not be connected to the network, i.e. that UEs may not have an RRC connection with the network and are in idle mode or in inactive mode. Alternatively, UEs may be in a power mode that is associated with having an RRC connection (for connected mode) or UEs may be in a power mode that is not associated with having an RRC connection (for idle more or inactive mode). In the context of some implementations of this embodiment, UEs are capable of acquiring their position through e.g. GNSS-based Positioning and the network is also aware of the position of the UE.

It is assumed that a UE is not connected to the network, when there is a task for the UE, the UE may request an RRC connection with the network. In order to connect with a non-terrestrial system such as e.g. a satellite mega-constellation, the UE may need to steer its beams towards the sky. However there may be lots of non-terrestrial TRPs (NT-TRPs) such as e.g. satellites that are in line-of-sight of the UE and therefore: there may be potentially lots of non-terrestrial TRPs the UE could establish a connection with. In order to assist the UE with establishing a connection with a NT-TRP, the UE may have to generate a transmit/receive beam towards that NT-TRP (in order to e.g. receive reference signals transmitted by that NT-TRP). The information in the transmit/receive beam may include UE's identifier, related parameters, etc. After the NT-TRP receives the request sent by the UE, it may send the request response to the UE, and then the UE may establish an RRC connection with the NT-TRP.

The detailed communication method in this disclosure is described in the following content.

FIG. 10 shows a schematic flow diagram of a communication method according to some examples of the present disclosure. As shown in FIG. 10, the method applied to the UE includes following steps 1001 to 1003.
1001: receiving a set of beam angle information (BAI) from a first network device.

Based on above content, when devices on the ground have completed initial access with the non-terrestrial network and are connected with the non-terrestrial network (as an example of the first network device), the devices have an RRC connection with the non-terrestrial network.

And then the first network device may send a set of BAI to the UE. In other words, the UE may receive a set of BAI from the first network device. And the set of BAI indicates mapping relationship between reference values and reference angular directions.

In some implementations, the set of BAI can also be called a table of BAI. And the table of BAI can be sent by the first network device using higher-layer signaling (e.g. RRC, or non-access stratum (NAS)) in the zenith domain and/or in the azimuth domain. shows an example of such a table with zenith angle. In Table 1, the reference values are zenith angle, and the reference angular directions are 4 bits BAI corresponding to zenith angle.

TABLE 1

| Zenith Angle [degrees] | BAI [4 bits] |
|---|---|
| −70 | 0000 |
| −60 | 0001 |
| −50 | 0010 |
| −40 | 0011 |
| −30 | 0100 |
| −20 | 0101 |
| −10 | 0110 |
| 0 | 0111 |
| 10 | 1000 |
| 20 | 1001 |
| 30 | 1010 |
| 40 | 1011 |
| 50 | 1100 |
| 60 | 1101 |
| 70 | 1110 |

As shown in the above Table 1, each zenith angle corresponds to an absolute angular direction in e.g. degrees and may be interpreted as the angular direction in which the UE may steer its spatial receive beam such that the boresight of the spatial receive beam is pointing in that angular direction. In some implementations, 0 degrees in the zenith domain corresponds to the UE's transmit/receive beam pointing vertically towards the sky. Each angular direction is associated with a BAI provided as a 4-bit codeword. In this example codewords have a 4-bit width because the default zenith BAI table contains 15 entries, other examples of zenith BAI tables with more or less number of entries may be considered or contemplated. The above table may contain one or more entries where each entry contains a 4-bit codeword, the UE may use any one or more entries within the above table in order to steer its spatial receive beam in the direction of any one or more entries.

In some implementations, the UE beam which is pointing its boresight towards the direction corresponding to a zenith angle of 0 degrees may be considered a “reference zenith beam”. It should be noted that a zenith angle of 0 degrees is equivalent to an elevation angle of 90 degrees.

In some implementations, there may be a reference coordinate system such that the zenith angle of zero degrees corresponds to the UE pointing its beam towards the sky (i.e. the reference beam), zenith angles with negative values may correspond to directions where the UE is pointing its beam on the left of the direction corresponding to zero degrees, zenith angles with positive values may correspond to directions where the UE is pointing its beam on the right of the direction corresponding to zero degrees.

In some implementations, there may be a reference coordinate system such that the zenith angle of zero degrees corresponds to the UE pointing its beam towards the sky (i.e. the reference beam), zenith angles with negative values may correspond to directions where the North Pole is located on the left of the reference zenith beam, zenith angles with positive values may correspond to directions where the South Pole is located on the right of the reference zenith beam.

As shown in Table 1, the differential value between two adjacent zenith angles is 10 degrees, and this differential value is not restricted in this disclosure. Illustratively, the differential value may be 5 degrees, 7 degrees, 20 degrees and so on. Similarly, the number of zenith angle in Table 1, as well as the number of bit for BAI are both not limited in this disclosure.

In some implementations, the UE may be provided with a table of BAI in the azimuth domain using higher-layer signaling (e.g. RRC signaling) as Table 2. In Table 2, the reference values are azimuth angle, and the reference angular directions are 4 bits BAI corresponding to azimuth angle.

TABLE 2

| Azimuth Angle [degrees] | BAI [4 bits] |
|---|---|
| 0 | 0000 |
| 30 | 0001 |
| 60 | 0010 |
| 90 | 0011 |
| 120 | 0100 |
| 150 | 0101 |
| 180 | 0110 |
| 210 | 0111 |
| 240 | 1000 |
| 270 | 1001 |
| 300 | 1010 |
| 330 | 1011 |

In some implementations, the UE beam which is pointing its boresight towards the North Pole with may be considered as a “reference azimuth beam” whose azimuth angle is equal to 0 degrees. It may be further assumed that the reference azimuth beam has a zenith angle of 90 degrees (or equivalently an elevation angle of 0 degrees).

In some implementations, there may be a reference coordinate system such that the azimuth angle of zero degrees corresponds to the UE pointing its beam towards the North Pole (i.e. the reference azimuth beam), azimuth angles with negative values may correspond to directions where the UE is pointing its beam on the left of the reference azimuth beam, zenith angles with positive values may correspond to directions where the UE is pointing its beam on the right of the reference azimuth beam.

As shown in Table 2, the differential value between two adjacent zenith angles is 30 degrees, and this differential value is not restricted in this application. Illustratively, the differential value may be 10 degrees, 20 degrees and so on. Similarly, the number of azimuth angle in Table 2, as well as the number of bit for BAI are both not limited in this application.

In some implementations, the table of BAI can just include the Table 1 above, which means the table of BAI just includes information related to zenith angle; or the table of BAI can just include the Table 2 above, which means the table of BAI just includes information related to azimuth angle; or the table of BAI includes both the Table 1 and the Table 2 above, which means the table of BAI includes information related to both zenith angle and azimuth angle.

Step 1001 is optional, when absent, the set of BAI could be predefined in the standard, or stored in both the first network device and the UE.
1002: receiving a first BAI subset from the first network device, wherein the first BAI subset includes at least one first BAI, each of the at least one first BAI represents a first value corresponding to a first angular direction, and the first value is included in the set of BAI.

In order to assist the UE in carrying out its communication functions with the non-terrestrial network (as an example of the first network device), the network may configure the UE with a “serving BAI list” (as an example of the first BAI subset) using higher-layer signaling (e.g. RRC signaling). An example of such higher-layer signaling in zenith domain is provided below:

```
servingZenithBAIlist = {
  bai#0 = 0101,
  bai#1 = 0110,
  bai#2 = 0111,
  bai#3 = 1000,
  bai#4 = 1001
}
```

Each serving zenith BAI (as an example of the first value) in the list above is included in the set of BAI mentioned above, and each serving zenith BAI corresponds to an angular direction (as an example of the first angular direction). So the first value is included in the reference values in the set of BAI, and the first angular direction is included in the reference angular directions in the set of BAI.

Comparing each serving zenith BAI with the set of BAI, it can be learned that the 4-bit codeword 0101 represents-20 degrees in zenith domain; codeword 0110 represents-10 degrees; codeword 0111 represents 0 degrees; codeword 1000 represents 10 degrees; codeword 1001 represents 20 degrees.

The above example of higher-layer signaling configures the UE with a serving zenith BAI list comprising five (serving) beams. Each beam may be a transmit/receive beam steered in the direction indicated by the respective entries in the servingZenithBAIlist parameter, i.e. the first beam may be steered using a zenith angle of −20 degrees, the second beam may be steered using a zenith angle of −10 degrees, the third beam may be steered using a zenith angle of 0 degrees, the fourth beam may be steered using a zenith angle of 10 degrees and the fifth beam may be steered using a zenith angle of 20 degrees. In some implementations, a zenith angle of 0 degrees corresponds to the direction where the UE's beam is pointed vertically towards the sky. The above configuration may result in something that may be illustrated as FIG. 11.

In FIG. 11, the UE 1101 can communicate with the first network device 1102 by serving BAIs. In some implementations, the serving BAI list can also define a communication cone between the UE 1101 and the first network device 1102. For example, in FIG. 11, the communication cone is an area whose largest zenith angle is 20 degrees and the smallest zenith angle is-20 degrees, which means that the UE 1101 can just communicate with the first network device 1102 within the communication cone. If the first network device 1102 moves beyond the communication cone, the UE 1101 may not communicate with it.

In some implementations, the configuration may be provided with a serving BAI list that each serving BAI contains two BAIs, including a first zenith BAI and a first azimuth BAI.

An example of a serving BAI list using a tuple of a first zenith BAI and a first azimuth BAI may be given as follows:

```
servingBAIlist = {
  bai#0 = {0101, 0100},
  bai#1 = {0110, 0100},
  bai#2 = {0111, 0100},
  bai#3 = {1000, 0100},
  bai#4 = {1001, 0100}
}
```

The above example of higher-layer signaling configures the UE with a serving BAI list includes five beams. Each beam may be a transmit/receive beam steered in the direction indicated by the respective entries in the servingBAIlist parameter, i.e. the first beam may be steered using a zenith angle of −20 degrees and an azimuth angle of 120 degrees, the second beam may be steered using a zenith angle of −10 degrees and an azimuth angle of 120 degrees, the third beam may be steered using a zenith angle of 0 degrees and an azimuth angle of 120 degrees, the fourth beam may be steered using a zenith angle of 10 degrees and an azimuth angle of 120 degrees, the fifth beam may be steered using a zenith angle of 20 degrees and an azimuth angle of 120 degrees. In some implementations, 0 degrees corresponds to the direction where the UE's beam is pointed vertically towards the sky, and an azimuth angle of 0 degrees corresponds to the direction where the UE's beam is pointed horizontally towards the north.

In addition, the serving BAI list may also include time for each serving BAI. By doing so, after the UE receiving the serving BAI list, it can send beams towards the given angular direction based on the given time. Thus, the communication efficiency may be improved.

It is noted that the set of BAI and the first BAI subset may be carried in the same message, and in this case, step 1001 and 1002 could be a single step.
1003: communicating with the first network device using the at least one first BAI.

As mentioned above, after the UE receives the serving BAI list, the UE can communicate with the first network device with the at least one first BAI by sending beams according to angular directions in the serving BAI list.

In some implementations, the step of communicating with the first network device using the at least one first BAI may be conducted when a first condition is met. That is to say, if the first condition is met, the UE can communicate with the first network device. If the first condition isn't met, the UE can't communicate with the first network device.

The first condition will be described in detail in the following content, which will not be described herein.

There may be several benefits from such configuration of serving BAIs. The first benefit is that it allows the network to define a so-called “communication cone” in a UE-specific manner, where the communication cone corresponds to a region of space where the UE steers its transmit/receive beam for communication purposes e.g. receiving/detecting/decoding physical layer channels such as PDCCH/PDSCH or transmitting physical layer channels such as PUCCH/PUSCH. Such serving BAIs may also be used by devices such as e.g. UEs to receive/detect/measure reference signals such as e.g. SS/PBCH blocks and/or non-zero power (NZP) CSI-RS.

Another benefit is that the configuration of serving BAIs may help to limit UE implementation complexity in terms of beam management because the UE is explicitly informed about beam angular directions where DL/UL communications are expected to take place. Another benefit is that the configuration of serving BAIs may help to set constraints on physical layer parameters such as the propagation delay, which helps to control the variations in the time domain of the reception of physical layer channels (e.g. PDCCH/PDSCH) and/or the transmission of physical layer channels (e.g. PUCCH/PUSCH).

It is noted that before the UE initiates initial access to the first network device, the UE may obtain public land mobile networks (PLMN) of the first network device. For example, the process may be: the UE scans RF channels to detect a NTN beam, and decode the system information carried in the NTN beam. Then the UE can obtain the PLMN in the system information, to initiate initial access to the first network device.

Because the UE can connect with a terrestrial network and a non-terrestrial network at the same time, in some implementations, the system information not only can include PLMN of a non-terrestrial network, but also can include PLMN of a terrestrial network, which may reduce the time for the UE to search the PLMN of the terrestrial network. The detailed description will be described in the following, which will not be described herein.

Apart from receiving the serving BAI list indicating angular directions of the serving beams from the first network device, the UE can also receive a candidate BAI list indicating angular directions of the candidate beams to be used for receiving/detecting/measuring physical layer signals such as e.g. SS/PBCH blocks and/or NZP CSI-RSs from a second network device, which is beyond the communication cone mentioned above.

The scenario of FIG. 9 in above embodiment for serving BAIs may be used for this embodiment, and the Tables in above embodiment for serving BAIs may be also used for this embodiment.

As shown in FIG. 12, the method applied to the UE includes following steps 1201 to 1203. 1201: receiving a set of beam angle information (BAI) from a first network device.

Based on the above content, when devices on the ground have completed initial access with the non-terrestrial network and are connected with the non-terrestrial network (as an example of the first network device), the devices have an RRC connection with the non-terrestrial network.

And then the first network device may send a set of BAI to the UE. In other words, the UE may receive a set of BAI from the first network device. And the set of BAI indicates mapping relationship between reference values and reference angular directions.

That is to say, for UEs in connected mode, they may be provided with a table of BAI as shown in Table 1 using higher-layer signaling (e.g. RRC) in the zenith domain, and/or in Table 2 using higher-layer signaling (e.g. RRC) in the azimuth domain.

Step 1201 is optional, when absent, the set of BAI could be predefined in the standard, or stored in both the second network device and the UE.
1202: receiving a second BAI subset from the first network device, wherein the second BAI subset includes at least one second BAI, each of the at least one second BAI represents a second value corresponding to a second angular direction, and the second value is included in the set of BAI.

In order to assist the UE in carrying out its beam/mobility management functions with the non-terrestrial network (as an example of the second network device), the first network device may configure the UE with a “candidate BAI list” (as an example of the second BAI subset) using higher-layer signaling (e.g. RRC signaling). An example of such higher-layer signaling in zenith domain is provided below:

```
candidateZenithBAIlist = {
  bai#0 = 0001,
  bai#1 = 0010,
  bai#2 = 0011,
  bai#3 = 0100,
  bai#4 = 1010,
  bai#5 = 1011,
  bai#6 = 1100,
  bai#7 = 1101
}
```

Each candidate zenith BAI (as an example of the second value) in the list above is included in the set of BAI mentioned above, and each in zenith domain zenith BAI corresponds to an angular direction (as an example of the second angular direction). So the second value is included in the reference values in the set of BAI, and the second angular direction is included in the reference angular directions in the set of BAI.

Comparing each candidate zenith BAI with the set of BAI, it can be learned that the 4-bit codeword 0001 represents-60 degrees in zenith domain; codeword 0010 represents-50 degrees; codeword 0011 represents-40 degrees; codeword 0100 represents-30 degrees; codeword 1010 represents 30 degrees; codeword 1011 represents 40 degrees; codeword 1100 represents 50 degrees; codeword 1101 represents 60 degrees.

The above example of higher-layer signaling configures a UE with a candidate zenith BAI list including eight beams. Each beam may be a transmit/receive beam steered in the direction indicated by the respective entries in the candidateZenithBAIlist parameter, i.e. the first beam may be steered using a zenith angle of −60 degrees, the second beam may be steered using a zenith angle of −50 degrees, and so forth. In some implementations, a zenith angle of 0 degrees corresponds to the direction where the UE's beam is pointed vertically towards the sky. The above configuration may result in something that may be illustrated as FIG. 13.

In FIG. 13, the second network device 1302 lies in the area 1 and another network device 1303 lies in the area 2, and the UE 1301 cannot establish a connection with the second network device 1302. Therefore the UE 1301 can't communicate with the second network device 1302 because the second network device 1302 doesn't lie in the communication cone of UE 1301. So does another network device 1303 in FIG. 13. But the UE can know about the second network device's position at different times because the first network device sends the second BAI subset to the UE.

In some implementations, the BAI entries configured in the candidateZenithBAIlist parameter may be restricted from being configured in the servingZenithBAIlist parameter in order to ensure that UEs don't use BAIs as both “serving” and “candidate” BAIs, which may lead to confusion in the UE behavior. For example, at a given time, a beam corresponding to this BAI is either used as a serving BAI or as a candidate BAI.

In some implementations, the UE may be provided with a table of BAI in the azimuth domain as a candidate BAI list using higher-layer signaling (e.g. RRC signaling) as Table 2:

In some implementations, the configuration may be provided with a candidate BAI list that each candidate BAI contains two BAIs, including a second zenith BAI and a second azimuth BAI.

An example of a candidate BAI list using a tuple of a second zenith BAI and a second azimuth BAI may be given as follows:

```
candidateBAIlist = {
  bai#0 = {0001, 0110},
  bai#1 = {0010, 0110},
  bai#2 = {0011, 0110},
  bai#3 = {0100, 0110},
  bai#4 = {1010, 0110},
  bai#5 = {1011, 0110},
  bai#6 = {1100, 0110},
  bai#7 = {1101, 0110}
}
```

The above example of higher-layer signaling configures the UE with a candidate BAI list including eight beams. Each beam may be a transmit/receive beam steered in the direction indicated by the respective entries in the candidateBAIlist parameter, i.e. the first beam may be steered using a zenith angle of −60 degrees and an azimuth angle of 180 degrees, the second beam may be steered using a zenith angle of −50 degrees and an azimuth angle of 180 degrees, and so forth. In some implementations, a zenith angle of 0 degrees corresponds to the direction where the UE's beam is pointed vertically towards the sky, and an azimuth angle of 0 degrees corresponds to the direction where the UE's beam is pointed horizontally towards the north.

In addition, the candidate BAI list may also include time for each candidate BAI. By doing so, after the UE receiving the candidate BAI list, it can send beams towards the given angular direction based on the given time. Thus, the signal transmission efficiency will be improved.

It is noted that the set of BAI and the second BAI subset may be carried in the same message, and in this case, step 1201 and 1202 could be a single step.
1203: receiving mobility/beam management reference signals from a second network device using the at least one second BAI.

Here the mobility/beam management reference signals is also called reference signals for at least one of mobility or beam management.

After the UE generates transmit/receive beams steered towards the given angular direction, the UE can receive the mobility/beam management reference signals sent by the second network device. And then the UE may determine the second network device's direction relative to the UE by determining the angle of the mobility/beam management reference signals.

In some implementations, the step of receiving mobility/beam management reference signals from the second network device using the at least one second BAI may be conducted when a second condition is met. That is to say, if the second condition is met, the UE can receive the mobility/beam management reference signals from the second network device. If the second condition isn't met, the UE can't receive the mobility/beam management reference signals from the second network device.

Such configuration of candidate BAIs helps to constraint UE implementation complexity as the UE doesn't spend time doing beam sweeping in irrelevant directions.

In some implementations, the usage and configuration of serving BAIs and candidate BAIs allows UEs to detect “incoming” non-terrestrial TRPs that are entering the range of interest, which is the communication cone, and to detect “outgoing” non-terrestrial TRPs. The reasons are as follows.

It can be learned from the above content that if the first condition is met, the UE can communicate with the first network device; if the first condition isn't met, the UE can't communicate with the first network device. The first condition includes that a first zenith angle of a beam is less than a first zenith angle threshold.

And if the second condition is met, the UE can receive the mobility/beam management reference signals from the second network device; if the second condition isn't met, the UE can't receive the mobility/beam management reference signals from the second network device. The second condition includes that a second zenith angle of a mobility/beam management reference signal is greater than a second zenith angle threshold.

Illustratively, the first network device and the second network device is not fixed name. For example, if the first network device moves from the communication cone to the cone defined by the candidate BAIs, the first network device may become the second network device. Take the FIG. 13 as an example, when a network device is in the area 1 or area 2, it may be called a second network device. When the network device moves to the communication cone, it may become a first network. If at this time, there is another network device in the area 1, this another network device may become the second network device.

Therefore, if the first network device is moving from a position where the first condition is met to a position where the second condition is met, the UE may confirm the first network device is “outgoing” the communication cone. Similarly, if the second network device is moving from a position where the second condition is met to a position where the first condition is met, the UE may confirm the second network device is “incoming” the communication cone.

Above mentioned two aspects will be described in detail in the following.

The feature of so-called “serving BAI switching” is introduced in this application, in particular the feature related to physical layer based triggers (L1-based triggers) is introduced. With such a feature, the UE could detect incoming non-terrestrial TRPs using candidate BAIs.

In some implementations, UE may be configured with candidate BAIs using higher-layer signaling e.g. RRC signaling and such candidate BAIs may be used by devices such as e.g. UEs to receive/detect/measure reference signals such as e.g. SS/PBCH blocks and/or NZP CSI-RS, which is mentioned in above embodiment. In addition, the UEs may be further configured to detect L1-based events such as the detection of a Beam/Mobility Management reference signal in successive candidate BAIs. In particular: the successive candidate BAIs are getting closer to the threshold of the “communication cone”.

The scenario of FIG. 9 in above embodiment for serving BAIs may be used for this embodiment, and the tables in above embodiment for serving BAIs may be also used for this embodiment.

Based on above implementations, a UE connected to the non-terrestrial network may be configured with 6 candidate beams (i.e. the UE is provided using higher-layer signaling e.g. RRC with a candidateBAIlist parameter containing 6 BAI entries) and 5 serving beams (i.e. the UE is provided using higher-layer signaling e.g. RRC with a serving BAI list parameter containing 5 BAI entries), as shown in the FIG. 14.

The UE may additionally be configured with a list of Beam/Mobility reference signals in order to detect any incoming NT-TRPs. In some implementations, the beam management (BM)/Mobility reference signals are configured such that they may use different time/frequency resources and/or different scrambling identities to initialize the pseudorandom noise binary sequences, when compared to the BM reference signals that are configured for use within the communication cone.

This list of Beam/Mobility reference signals may be provided as a list of reference signals, as shown in the example below:

BeamMobilityMgmtConfig = {

| | |
|---|---|
| bmSsbResourceList | SEQUENCE (SIZE(1..n)) OF ssb-Resource, optional |
| bmCsirsResourceList | SEQUENCE (SIZE(1..m)) OF nzp-csi-rs-Resource, |

optional
}

In the above example, the UE is configured with an integer number n of SS/PBCH blocks for Beam/Mobility Management and the UE is configured with an integer number m of NZP CSI-RSs for Beam/Mobility Management. The UE may be further configured with a reporting configuration for the purpose of detecting incoming NT-TRPs. One such physical layer event may be the detection of a “BM-RS whose zenith angle has become lower than a threshold (as an example of the first zenith angle threshold)”. An example configuration of such a physical layer event is provided below:

```
BeamMobilityMgmtConfig = {
bmTriggerConfig = {
  eventBM-T1 = {
    triggerQuantity = ZenithAngle,
    threshold = 25 degrees,
    hysteresis = 3 degrees,
    timeToTrigger = 1000 ms
  }
}
}
```

The above higher-layer signaling configures the UE to detect incoming NT-TRPs (as an example of the second network device) by monitoring a BM-RS (or equivalently a mobility-RS) zenith angle and comparing it against the threshold of 25 degrees. The L1-based event is called “T1” which in this context means that the UE may compare whether a BM-RS's zenith angle has become lower than a threshold. The zenith angle may be calculated e.g. in absolute value, i.e. a zenith angle below zero (i.e. negative) would be taken as a positive value while a zenith angle above zero (i.e. positive) would remain unchanged. The trigger condition is that the zenith angle measured by the UE is below the threshold of 25 degrees, subject to a hysteresis parameter of 3 degrees, and for a duration of 1000 milli-seconds. Effectively: this means that the UE is detecting a reference signal from an incoming NT-TRP and this NT-TRP is considered to have entered the communication cone of the UE (i.e. the region of space where the UE may perform DL/UL communication with an NT-TRP), as shown in FIG. 15.

As shown in FIG. 14, the absolute value of the zenith angle threshold 1 and the zenith angle threshold 2 is 25 degrees. In FIG. 14, if the second network device moves to the right-hand side of the zenith angle threshold 1, the second network device is considered to have entered the communication cone.

In some implementations, the UE may implicitly derive the threshold for the zenith angle from the set of zenith BAIs that are configured in serving zenith BAI list and candidate zenith BAI list. As an example, the threshold may be derived as the middle value between the lowest zenith angle value in the candidate zenith BAI list and the highest zenith angle value in the serving zenith BAI list.

For example, in FIG. 14, the lowest zenith angle value in the candidate zenith BAI list is 30 degrees, and the highest zenith angle value in the serving zenith BAI list is 20 degrees. So the middle value is 25, which is the threshold.

There may be several benefits from such configuration of L1-based events or triggers. Non-terrestrial TRPs such as e.g. LEO satellites travel along orbits, and therefore they may naturally “come and go” from the perspective of UEs. Such “incoming” non-terrestrial TRPs may become TRPs that the UE communicates with using the higher-layer configured serving BAIs. So the first benefit is that it allows the UE to detect “incoming” non-terrestrial TRPs, and in particular it may allow the UE to determine the appropriate time for switching its beam towards the incoming NT-TRP.

The other benefit is that such configuration of L1-based events or triggers are entirely UE-centric because each UE may determine the appropriate time for switching its beam towards the incoming NT-TRP. Another benefit is that such L1-based trigger configuration is made in a network transparent manner, i.e. without providing UEs with information about ephemeris or orbital information corresponding to non-terrestrial TRPs.

In some implementations, the UE may be further configured with L1-based triggers or events where the UE detects “outgoing” non-terrestrial TRPs. One such physical layer event may be the detection of a “BM-RS whose zenith angle has become higher than a threshold (as an example of the second zenith angle threshold)”. An example configuration of such a physical layer event is provided below:

```
BeamMobilityMgmtConfig = {
bmTriggerConfig = {
  eventBM-T2 = {
    triggerQuantity = ZenithAngle,
    threshold = 25 degrees,
    hysteresis = 3 degrees,
    timeToTrigger = 1000 ms
  }
}
}
```

The above higher-layer signaling configures a UE to detect outgoing NT-TRPs by monitoring a BM-RS zenith angle and comparing it against the threshold of 25 degrees. The L1-based event is called “T2” which in this context means that the UE may compare whether a BM-RS's zenith angle has become higher than a threshold. The zenith angle may be calculated e.g. in absolute value, i.e. a zenith angle below zero (i.e. negative) would be taken as a positive value while a zenith angle above zero (i.e. positive) would remain unchanged. The trigger condition is that the zenith angle measured by the UE is above the threshold of 25 degrees, subject to a hysteresis parameter of 3 degrees, and for a duration of 1000 milli-seconds. Effectively: this means that the UE is detecting a reference signal from an outgoing NT-TRP and this NT-TRP is considered to have exited the communication cone of the UE (i.e. the region of space where the UE may perform DL/UL communication with an NT-TRP), as shown in FIG. 16.

As shown in FIG. 14, if the first network device moves to the right handside of the zenith angle threshold 2, the first network device is considered to have exited the communication cone.

In some implementations, the first zenith angle threshold and the second zenith angle threshold can be the same (e.g. 25 degrees) and may be different, which is not limited in this application.

One difference between the detection of incoming NT-TRPs and the detection of outgoing NT-TRPs may be that any physical layer detection (and any corresponding signal processing) for incoming NT-TRPs is occurring on candidate BAIs, while any physical layer detection (and any corresponding signal processing) for outgoing NT-TRPs is occurring on serving BAIs.

There may be several benefits from such configuration of L1-based events or triggers. The first benefit is that it allows the UE to detect “outgoing” non-terrestrial TRPs, and in particular it may allow the UE to determine the appropriate time for scanning for incoming NT-TRPs on candidate BAIs. Another benefit is that such configuration of L1-based events or triggers are entirely UE-centric because each UE may determine the appropriate time for switching its beam towards the incoming NT-TRP. Another benefit is that the serving BAI switching mechanism is a UE-initiated one, since the UE is the one that detects the appropriate time for switching from a serving BAI (that may be aimed towards an outgoing NT-TRP) to switching to another serving BAI (that may be aimed towards an incoming NT-TRP).

In some implementations, the UE may also additionally send signaling to the outgoing NT-TRP that it is going to switching its current serving BAI towards another serving BAI (that may be aimed towards an incoming NT-TRP). The incoming NT-TRP may be an adjacent NT-TRP to the outgoing NT-TRP located e.g. on the same orbit as the outgoing NT-TRP, as shown in the FIG. 17.

In some implementations, the incoming and outgoing NT-TRPs may exchange further signaling information regarding the transfer of the UE's RRC connection context using e.g. laser inter-satellite links.

In some implementations, different NT-TRPs such as e.g. satellites may exchange backhaul signaling information between themselves using e.g. laser inter-satellite links (LISLs). In some other embodiments, different NT-TRPs such as e.g. satellites may exchange backhaul signaling information between themselves by sending physical layer channels e.g. PDCCH/PDSCH to a NTN Gateway acting as a relay between e.g. two or more NT-TRPs. The backhaul signaling information may include information indicative of e.g. UE identity, UE scheduling context, RLC traffic packets, packet data convergence protocol (PDCP) traffic packets, TCP/IP traffic packets, the zenith/azimuth BAI the UE may switch to, the time that the source NT-TRP may stop serving the UE, the time that the target NT-TRP may start serving the UE, the time interval that the switching may take, etc. An example of this higher-layer signaling (which may be e.g. RRC) is shown below:

| backhaulSignalingConfig = { | |
|---|---|
| ueIdentity, | |
| ueSchedulingContext = { | |
| instantaneousRate, averageRate, trafficQoS, ... | |
| } | |
| rlcTrafficPacketQueue, | |
| pdcpTrafficPacketQueue | optional, |
| tcpIpTrafficPacketQueue | optional, |
| ueZenithBAI, | |
| ueAzimuthBAI | optional, |
| sourceSwitchingTime | optional, |
| targetSwitchingTime | optional, |
| switchingTimeInterval | optional, |

...
}

In some implementations, the higher-layer signaling carrying the list of zenith and/or azimuth BAIs may indicate an angular direction and may implicitly indicate a half-power beam width (HPBW) for each beam. As an example, if there are two zenith BAI entries configured where the first entry has a codeword of “000” and corresponds to an angular direction of zero degrees and the second entry has a codeword of “001” and corresponds to an angular direction of ten degrees, then the implicit indication from such a higher-layer configuration is that the beams are generated such that they have a HPBW of ten degrees because the difference between the first and second entries of zenith BAI is ten degrees. Such a behavior may allow the UE to generate beams such that they don't interfere with each-other through e.g. leakage.

In some implementations, the UE can connect with a terrestrial network (as an example of the base station) and non-terrestrial network (as an example of the first network device) at the same time. But Terrestrial network and Non-Terrestrial network are seen as “separate” networks by UEs because they are seen as individual “public land mobile networks” (PLMNs) with their own unique code. The PLMN information includes the mobile country code (MCC) and mobile network code (MNC) which are unique numbers allocated by the International Telecommunication Union-Telecommunication Standardization Sector (ITU-T). In 5G NR, UEs are required to scan for all RF channels, detect the strongest cell and find the available PLMNs in order to report them to its non-access stratum (NAS) layer and register with the appropriate PLMN.

That is to say, before the UE conducts the initial access to the non-terrestrial network, it is required to scan for all RF channels, detect the strongest cell and find available PLMN. Before the UE conducts the initial access to the terrestrial network, it is also required to do the same thing as above. This results in the UE having to run initial access-related procedures for each of the terrestrial and non-terrestrial networks. The connecting complexity is increased.

Therefore, the feature of so-called “Joint TN/NTN PLMN” is introduced in this application, in particular the procedure of joint TN/NTN PLMN selection is introduced. A joint TN/NTN PLMN may be defined by using two Mobile Country Codes (MCC) and two Mobile Network Codes (MNC), as shown in the example below:

$$Joint TN / NTN PLMN = \{ \{ {MCC}_{T N} , {MNC}_{T N} \} , \{ {MCC}_{N T N} , {MNC}_{N T N} \} \}$$

In some implementations, a joint TN/NTN PLMN may have the further constraint that MCCIN and MCCNIN are equal, in which the definition of the joint TN/NTN PLMN may be further simplified to the following:

$$Joint TN / NTN PLMN = \{ M CC , \{ MN {C}_{T N} , {MNC}_{N T N} \} \}$$

Both the MCC and MNC may be uniquely assigned integer values, assigned by regulatory authorities such as e.g. the ITU-T.

In some implementations, before the UE initiates initial access to the non-terrestrial network (e.g. the first network device), the UE may obtain the system information sent by the non-terrestrial network. In addition to a second PLMN information of the non-terrestrial network, the system information may also include a first PLMN information of the terrestrial network (e.g. a base station).

Illustratively, the first PLMN information and the second PLMN information can be called a joint TN/NTN PLMN (as an example of the PLMN information set). Then the UE can use the first PLMN information to conduct following procedures such as cell selection, so as to communicate with the terrestrial network. By doing so, when the UE connects two networks, the procedure for UE connecting the terrestrial network may be easier, and the connecting complexity will be decreased.

Then the detailed description will be described below.

The scenario of FIG. 9 in above embodiment may be used for this embodiment.

For devices (UEs) on the ground not connected with the non-terrestrial network, which means that devices have no RRC connection with the non-terrestrial network. They need to perform basic functions such as PLMN selection before initiating Initial Access. As part of performing PLMN selection: UEs need to scan for RF channels and find the appropriate joint PLMN.

PLMN selection may include in a number of steps such as:
1) Scanning RF channels associated with a given frequency band and attempt to detect a NTN beam, where a given NTN beam may be associated with a given SS/PBCH block.
2) Upon finding a NTN beam, attempt to detect and decode the Master Information Block (MIB) from SS/PBCH blocks.
3) Upon decoding the MIB from a detected SS/PBCH block, detecting and decoding the PDSCH transmission carrying System Information Block 1 (SIB1).
4) Compare the value of the PLMN carried in SIB1 with the value of the PLMN provided by the UE's Non-Access Stratum (NAS) layer.

FIG. 18 shows a schematic diagram of procedures for UE to camp on an NTN beam. In the above example, the UE may have stored NTN information or may not have stored NTN information, such as e.g. a NTN synchronization raster, NTN frequency bands or NTN RF channels. The first step followed by the UE may be to select an NTN beam. If the UE has stored NTN information, such as NTN frequency bands and NTN RF channels, then in above step 1), the UE may scan the given RF channels associated with the given frequency bands. If the UE didn't store NTN information, the UE may scan all RF channels associated with all frequency bands.

Upon finding an NTN beam, the UE may start to “camp on the NTN beam”, which may mean that the UE monitors for System Information within the NTN beam. System Information may be carried in e.g. System Information Blocks (SIB).

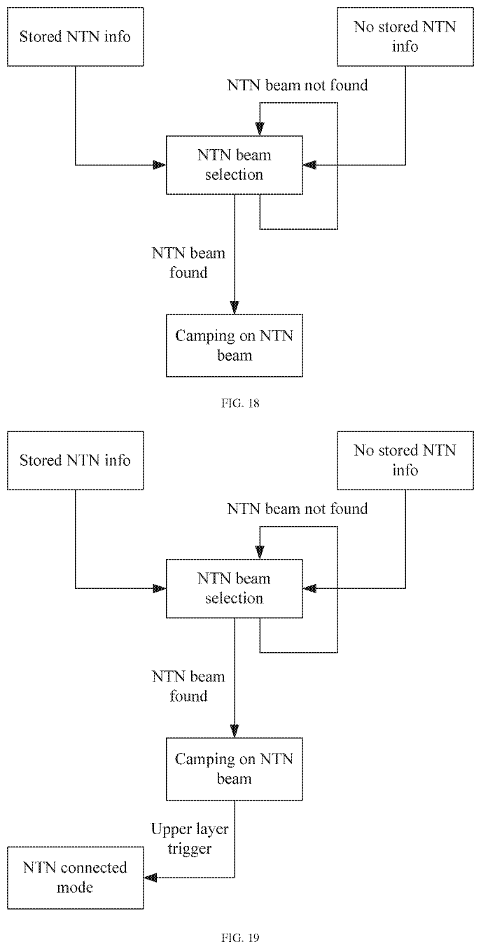

Based on upper layer triggers, such as e.g. traffic services or application services, the UE may initiate the Initial Access procedure in order to establish an RRC connection, which is shown in the FIG. 19.

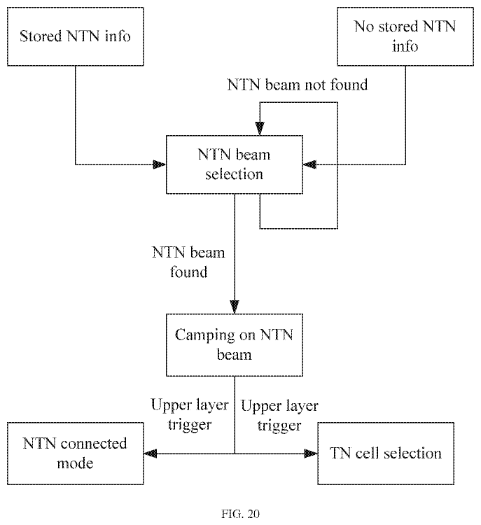

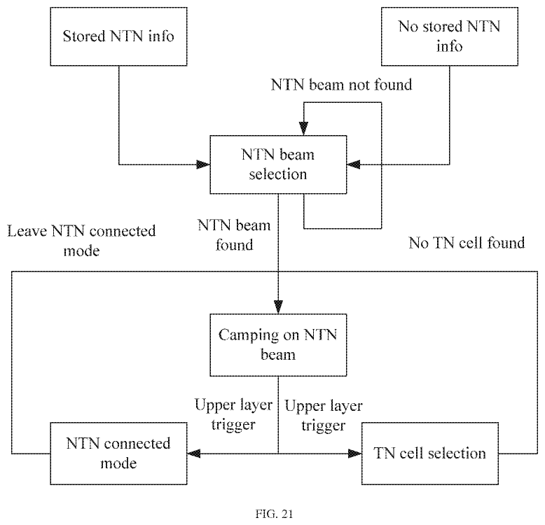

In other scenarios or use-cases, the UE may report the available PLMN to its NAS layer. If the UE was able to find a joint TN/NTN PLMN, which means that the UE can connect a terrestrial network too, the NAS layer may instruct the UE to also initiate the TN cell selection function, as shown in the FIG. 20:

By using the joint TN/NTN PLMN selection function, the UE doesn't need to randomly scan for RF channels in order to find a suitable cell, System Information in the NTN system may carry information regarding the TN synchronization raster, physical cell identities (PCI) of interest, frequency bands of interest in order to accelerate Cell Search and Cell Selection. An example of such a SIB is provided below:

```
SIB = {
tnSyncRaster = {
  absoluteRadioFrequencyChannelNumber#0 = 60,
  absoluteRadioFrequencyChannelNumber#1 = 70,
  ...
  absoluteRadioFrequencyChannelNumber#n = 2390
}
tnPCIList = {
  pci#0 = 10,
  pci#1 = 14,
  ...
  pci#m = 905
}
}
```

That is to say, the system information in the NTN system may further include RF channels and PCIs. In this way, after the UE obtains the first PLMN information of the terrestrial network, the UE may select a target cell using the given RF channels and PCIs in the system information, where the target cell is associated with the terrestrial network. And then, the UE may communicate with the terrestrial network. In conclusion, the RF channels and PCIs in the system information may reduce the time duration for the UE to select the target cell to connect with the terrestrial network.

The configuration above is just an illustrative example. The content of SIB may be set according to actual application scenarios.

If the UE leaves NTN connected mode or if the UE fails to find a suitable TN cell, the UE may simply leave the NTN connected mode or the TN cell selection and return to camping on the NTN beam, as shown in the FIG. 21.

There may be several benefits from such design of joint TN/NTN PLMN values. Such design may allow UEs to find TN and/or NTN network more easily and more quickly instead of the UE attempting to connect to either network in a stand-alone manner. Joint TN/NTN PLMN may also reduce UE power consumption as a UE is in idle mode (or equivalently in a power mode where the UE is in sleep, or deep sleep). This also helps to make Initial Access procedure much faster as one network (e.g. NTN) may provide information about the other network (e.g. TN).

In some implementations, the UE may store information about a home coverage area for NTN, which may be used to make the procedure for finding a NTN beam faster. The home coverage area may contain information about e.g. a coverage area identity, SS/PBCH block center frequencies, physical beam identities, etc.

In some implementations, the UE may store information about a candidate coverage area for NTN, which may be used to make the procedure for finding a NTN beam faster. The candidate coverage area may contain information about e.g. a coverage area identity, SS/PBCH block center frequencies, physical beam identities, etc.

In some implementations, the UE may be configured a set of values corresponding to beam angle information (BAI) using higher-layer signaling, where the BAI is not a quantized value corresponding to an angular direction in e.g. the Azimuth/Zenith domain, the BAI may be e.g. an integer positive/negative value corresponding to an angular direction.

In some implementations, the number of primary BAI entries a UE may be configured using higher-layer signaling may be configured in correspondence with the UE's Capability, where the UE may e.g. report a maximum number of primary BAI entries it supports as part of the UE Capability Report.

In some implementations, the number of candidate BAI entries a UE may be configured using higher-layer signaling may be configured in correspondence with the UE's Capability, where the UE may be e.g. report a maximum number of candidate BAI entries it supports as part of the UE Capability Report.

In some implementations, the UE may report to the network its capability in terms of the visibility cone using e.g. an integer value for the angle of the visibility cone, where the integer value may be an angle expressed in the local coordinate system of the UE. The integer value may be a positive or negative value.

In some implementations, the UE may report to the network its capability in terms of the visibility cone using e.g. an integer value for the angle of the visibility cone, where the integer value may be an angle expressed in the Earth Centric Earth Fixed (ECEF) coordinate system. The integer value may be a positive or negative value.

In some implementations, the UE may indicate a maximum number of BAI entries it can support to the network as part of the UE Capability Report, however the network may have the flexibility to configure any number of BAI entries as primary BAIs or candidate BAIs so long as the sum of the primary BAIs and candidate BAIs doesn't exceed the maximum number of BAI entries supported by the UE.

In some aspects of the present application, there is provided an apparatus/chipset system comprising means (e.g., at least one processor) to implement a method implemented by (or at) a UE of the present application. The apparatus/chipset system may be the UE (that is, a terminal device) or a module/component in the UE. In details, the at least one processor may execute instructions stored in a computer-readable medium to implement the method.

In some aspects of the present application, there is provided an apparatus/chipset system comprising means (e.g., at least one processor) to implement the method implemented by (or at) a network device (e.g., base station) of the present application. The apparatus/chipset system may be the network device or a module/component in the network device. In details, the at least one processor may execute instructions stored in a computer-readable medium to implement the method.

In some aspects of the present application, there is provided a system comprising at least one of an apparatus in (or at) a UE of the present application, or an apparatus in (or at) a network device of the present application.

In some aspects of the present application, there is provided a method performed by a system comprising at least one of an apparatus in (or at) a UE of the present application, and an apparatus in (or at) a network device of the present application.

In some aspects of the present application, there is provided a computer program comprising instructions. The instructions, when executed by a processor, may cause the processor to implement a method of the present application.

In some aspects of the present application, there is provided a non-transitory computer-readable medium storing instructions, the instructions, when executed by a processor, may cause the processor to implement a method of the present application.

The solutions described in the application is applicable to a next generation (e.g. sixth generation (6G) or later) network, or a legacy (e.g. 5G, 4G, 3G or 2G) network.

It will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device/apparatus or accessible or connectable thereto. Computer/processor readable/executable instructions to implement a method, an application or a module described herein may be stored or otherwise held by such non-transitory computer/processor readable storage media.

It could be noted that the message in the application could be replaced with information, which may be carried in one single message, or be carried in more than one separate message.

Without special noting, the terms “apparatus” and “device” are used exchangeable, and the terms “identity” and “identifier” are used exchangeable.

In the application, the word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

In the application, the words “first”, “second”, etc., when used before a same term (e.g., ED, or an operating step) does not mean an order or a sequence of the term. For example, the “first ED” and the “second ED”, means two different EDs without specially indicated, and similarly, although the present application describes methods and processes with steps in a certain order, one or more steps of the methods and processes may be omitted or altered as appropriate. One or more steps may take place in an order other than that in which they are described, as appropriate. For example, the “first step” and the “second step” means two different operating steps without specially indicated, but does not mean the first step have to happen before the second step. The real order depends on the logic of the two steps.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The present application encompasses various embodiments, including not only method embodiments, but also other embodiments such as apparatus embodiments and embodiments related to non-transitory computer readable storage media. Embodiments may incorporate, individually or in combinations, the features disclosed herein.

The term “receive”, “detect” and “decode” as used herein can have several different meanings depending on the context in which these terms are used. For example, without special note, the term “receive” may indicate that information (e.g., DCI, or MAC-CE, RRC signaling or TB) is received successfully by the receiving node, which means the receiving side correctly detect and decode it. In this scenario, “receive” may cover “detect” and “decode” or may indicates same thing, e.g., “receive paging” means decoding paging correctly and obtaining the paging successfully. Accordingly, “the receiving side does not receive paging” means the receiving side does not detect and/or decoding the paging. “Paging is not received” means the receiving side tries to detect and/or decoding the paging, but not obtain the paging successfully. The term “receive” may sometimes indicate that a signal arrives at the receiving side, but does not mean the information in the signal is detected and decoded correctly, then the receiving side need perform detecting and decoding on the signal to obtain the information carried in the signal. In this scenario, “receive”, “detect” and “decode” may indicate different procedure at receiving side to obtain the information. Although this application refers to illustrative embodiments, this is not intended to be construed in a limiting sense. Various modifications and combinations of the illustrative embodiments, as well as other embodiments of the application, will be apparent to persons skilled in the art upon reference to the description. When combining two or more embodiments, not all the features in the embodiments to be combined are necessary for the combination.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present application.

Although aspects of the present application have been described with reference to specific features and embodiments thereof, various modifications and combinations can be made thereto without departing from the application. The description and drawings are, accordingly, to be regarded simply as an illustration of some embodiments of the application as defined by the appended claims, and are contemplated to cover any and all modifications, variations, combinations or equivalents that fall within the scope of the present application. Therefore, although embodiments and potential advantages have been described in detail, various changes, substitutions and alterations can be made herein without departing from the application as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the application of the present application, processes, machines, manufacture, compositions of matter, means, methods, or steps, presently existing or later to be developed, that perform substantially the same function or achieve substantially the same result as the corresponding embodiments described herein may be utilized according to the present application. Accordingly, the appended claims are intended to include within their scope of such processes, machines, manufacture, compositions of matter, means, methods, or steps.

What is claimed is:

1. An apparatus, comprising:
at least one processor and at least one memory coupled to the at least one processor, wherein the at least one memory stores program instructions that, when executed by the at least one processor, cause the apparatus to perform operations comprising:
receiving a set of beam angle information (BAI) from a first network device;
receiving a BAI subset from the first network device, wherein the BAI subset includes at least one BAI, each of the at least one BAI represents a value corresponding to an angular direction, and the value is included in the set of BAI; and
communicating with the first network device using the at least one BAI.

2. The apparatus of claim 1, wherein the set of BAI indicates a mapping relationship between reference values and reference angular directions, the reference values include the value, and the reference angular directions include the angular direction.

3. The apparatus of claim 2, wherein the reference angular directions include at least one of zenith angles or azimuth angles of beams.

4. The apparatus of claim 3, wherein communicating with the first network device using the at least one BAI, comprises:
communicating with the first network device using the at least one BAI when a condition is met, wherein the condition includes that a zenith angle of a beam is less than a zenith angle threshold.

5. The apparatus of claim 1, wherein the operations further comprise:
determining a first public land mobile network (PLMN) information used for communicating with a base station, wherein the first PLMN information is determined based on a PLMN information set included in system information from the first network device, and the PLMN information set includes a second PLMN information used for communication between the apparatus and the first network device, and includes the first PLMN information; and
communicating with the base station based on the first PLMN information.

6. The apparatus of claim 5, wherein the system information further includes radio frequency (RF) channels and physical cell identities (PCIs), and the operations further comprise:
selecting a target cell based on the RF channels and the PCIs, wherein the target cell is associated with the base station.

7. An apparatus, comprising:
at least one processor and at least one memory coupled to the at least one processor, wherein the at least one memory stores program instructions that, when executed by the at least one processor, cause the apparatus to perform operations comprising:
receiving a set of beam angle information (BAI) from a first network device;
receiving a BAI subset from the first network device, wherein the BAI subset includes at least one BAI, each of the at least one BAI represents a value corresponding to an angular direction, and the value is included in the set of BAI; and
receiving reference signals for at least one of mobility or beam management from a second network device using the at least one BAI.

8. The apparatus of claim 7, wherein the set of BAI indicates a mapping relationship between reference values and reference angular directions, the reference values include the value and the reference angular directions include the angular direction.

9. The apparatus of claim 8, wherein the reference angular directions include at least one of zenith angles or azimuth angles of beams.

10. The apparatus of claim 9, wherein receiving reference signals for at least one of mobility or beam management from a second network device using the at least one BAI comprises:
receiving the reference signals for at least one of mobility or beam management from the second network device using the at least one BAI when a condition is met, wherein the condition includes that a zenith angle of a reference signal of the reference signals for at least one mobility or beam management is greater than a zenith angle threshold.

11. A method applied to an apparatus, comprising:
receiving a set of beam angle information (BAI) from a first network device;
receiving a BAI subset from the first network device, wherein the BAI subset includes at least one BAI, each of the at least one BAI represents a value corresponding to an angular direction, and the value is included in the set of BAI; and
communicating with the first network device using the at least one BAI.

12. The method of claim 11, wherein the set of BAI indicates a mapping relationship between reference values and reference angular directions, the reference values include the value and the reference angular directions include the angular direction.

13. The method of claim 12, wherein the reference angular directions include at least one of zenith angles or azimuth angles of beams.

14. The method of claim 13, wherein communicating with the first network device using the at least one BAI comprises:
communicating with the first network device using the at least one BAI when a condition is met, wherein the condition includes that a zenith angle of a beam is less than a zenith angle threshold.

15. The method of claim 11, wherein the method further comprises:
determining a first public land mobile network (PLMN) information used for communicating with a base station, wherein the first PLMN information is determined based on a PLMN information set included in system information from the first network device, and the PLMN information set includes a second PLMN information used for communication between the apparatus and the first network device, and includes the first PLMN information; and
communicating with the base station based on the first PLMN information.

16. The method of claim 15, wherein the system information further includes radio frequency (RF) channels and physical cell identities (PCIs), and the method further comprises:
selecting a target cell based on the RF channels and the PCIs, wherein the target cell is associated with the base station.
